(19) United States
(12) Patent Application Publication
(10) Pub. No.: US 2024/0388934 A1
(43) Pub. Date: Nov. 21, 2024

(54) METHOD AND DEVICE FOR DETERMINING MEASUREMENT SEQUENCE FOR FREQUENCIES ACCORDING TO BASE STATION CONFIGURATION IN NEXT GENERATION MOBILE COMMUNICATION SYSTEM

(71) Applicant: Samsung Electronics Co., Ltd., Gyeonggi-do (KR)

(72) Inventors: Sangyeob JUNG, Gyeonggi-do (KR); Anil AGIWAL, Gyeonggi-do (KR)

(21) Appl. No.: 18/667,094

(22) Filed: May 17, 2024

Related U.S. Application Data
(60) Provisional application No. 63/502,701, filed on May 17, 2023.

(30) Foreign Application Priority Data
May 2, 2024 (KR) 10-2024-0058625

(51) Int. Cl. H04W 24/08

(52) U.S. Cl. CPC H04W 24/08

(57) ABSTRACT

The disclosure relates to a 5G or 6G communication system for supporting a higher data transmission rate. A device and a method are provided for configuring a measurement sequence of frequencies in a wireless communication system. A method performed by a base station includes transmitting, to a terminal, a radio resource control message including configuration information on at least one measurement to be performed by the terminal, the configuration information including first information on measurement objects and second information on a report configuration; and receiving, from the terminal, a measurement report including at least one measurement result based on the configuration information. The first information includes information indicating a measurement sequence of a corresponding measurement object among the measurement objects.

### CROSS-REFERENCE TO RELATED APPLICATION(S)

This application is based on and claims priority under 35 U.S.C. § 119 to U.S. Provisional Patent Application No. 63/502,701, filed on May 17, 2023, in the U.S. Patent and Trademark Office, and Korean Patent Application No. 10-2024-0058625, filed on May 2, 2024, in the Korean Intellectual Property Office, the disclosures of which are incorporated herein by reference in their entireties.

### BACKGROUND

### 1. Field

The disclosure relates generally to a wireless communication system, and more particularly, to a method and a device for configuring a measurement sequence of frequencies in a wireless communication system.

### 2. Description of Related Art

Fifth generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmWave) bands, such as 28 GHz and 39 GHz. In addition, it has been considered to implement sixth generation (6G) mobile communication technologies referred to as beyond 5G systems in terahertz (THz) bands such as 95 GHz to 3 THz bands, to achieve transmission rates fifty times faster than 5G mobile communication technologies and ultra-low latencies one-tenth of 5G mobile communication technologies.

In the initial stage of 5G mobile communication technologies, to support services and to satisfy performance requirements in connection with enhanced mobile broadband (eMBB), ultra reliable & low latency communications (URLLC), and massive machine-type communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large-capacity data transmission and a polar code for highly reliable transmission of control information, layer 2 (L2) pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for securing coverage in an area in which communication with terrestrial networks is unavailable, and positioning.

Moreover, there has been ongoing standardization in wireless interface architecture/protocol fields regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel for simplifying random access procedures (2-step RACH for NR). There also has been ongoing standardization in system architecture/service fields regarding a 5G baseline architecture (for example, service based architecture or service based interface) for combining network functions virtualization (NFV) and software-defined networking (SDN) technologies, and mobile edge computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for securing coverage in THz bands of 6G mobile communication technologies, full dimensional multiple input multiple output (FD-MIMO), multi-antenna transmission technologies such as array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

A base station configures frequencies to be measured for a terminal so as to properly serve the terminal, and the terminal performs a measurement operation for the configured frequencies and then provides information on the result to the base station. The base station may determine a cell in which the terminal is to be served, by considering the measurement result from the terminal, and may perform configuration such as handing over the terminal to the cell or adding a connection to the cell to the terminal. Conventionally, the terminal measures the frequencies configured by the base station in a random sequence, resulting in a deficiency in a frequency optimized to support a particular service.

As such, there is a need in the art for a method and apparatus by which a measurement result for a particular frequency is preferentially reported according to a configuration, to optimally provide a service used by a terminal.

### SUMMARY

The disclosure has been made to address at least the above-mentioned problems and/or disadvantages and to provide at least the advantages described below.

Accordingly, an aspect of the disclosure is to provide a method and a device for configuring a measurement sequence together in configuring frequencies to be measured for a terminal.

In accordance with an aspect of the disclosure, a method performed by a base station in a wireless communication system includes transmitting, to a terminal, a radio resource control message including configuration information on at least one measurement to be performed by the terminal, the configuration information including first information on measurement objects and second information on a report configuration, and receiving, from the terminal, a measurement report including at least one measurement result based on the configuration information, wherein the first information includes information indicating a measurement sequence of a corresponding measurement object among the measurement objects.

In accordance with an aspect of the disclosure, a method performed by a terminal in a wireless communication system includes receiving, from a base station, a radio resource control message including configuration information on at least one measurement to be performed by the terminal, the configuration information including first information on measurement objects and second information on a report configuration, and transmitting, to the base station, a measurement report including at least one measurement result based on the configuration information, wherein the first information includes information indicating a measurement sequence of a corresponding measurement object among the measurement objects.

In accordance with an aspect of the disclosure, aa base station in a wireless communication system includes a transceiver and a controller configured to control the transceiver to transmit, to a terminal, a radio resource control message including configuration information on at least one measurement to be performed by the terminal, the configuration information including first information on measurement objects and second information on a report configuration, and control the transceiver to receive, from the terminal, a measurement report including at least one measurement result based on the configuration information, wherein the first information includes information indicating a measurement sequence of a corresponding measurement object among the measurement objects.

In accordance with an aspect of the disclosure, a terminal in a wireless communication system includes a transceiver and a controller configured to control the transceiver to receive, from a base station, a radio resource control message including configuration information on at least one measurement to be performed by the terminal, the configuration information including first information on measurement objects and second information on a report configuration, and control the transceiver to transmit, to the base station, a measurement report including at least one measurement result based on the configuration information, wherein the first information includes information indicating a measurement sequence of a corresponding measurement object among the measurement objects.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a long term evolution (LTE) system according to an embodiment;

FIG. 2 illustrates a radio protocol structure of an LTE system according to an embodiment;

FIG. 3 illustrates a structure of a next-generation mobile communication system according to an embodiment;

FIG. 4 illustrates a radio protocol structure of a next-generation mobile communication system according to an embodiment;

FIG. 5 illustrates a process in which a terminal transmits a measurement result message to a base station in a next generation mobile communication system according to an embodiment;

FIG. 6 illustrates a process in which a terminal transmits a measurement result message to a base station in a next generation mobile communication system according to an embodiment;

FIG. 7 illustrates a process in which a terminal transmits a measurement result message to a base station in a next generation mobile communication system according to an embodiment;

FIG. 8 illustrates a process in which a terminal transmits a measurement result message to a base station in a next generation mobile communication system according to an embodiment;

FIG. 9 illustrates a process in which a terminal transmits a measurement result message to a base station in a next generation mobile communication system according to an embodiment;

FIG. 10 illustrates an internal structure of a terminal according to an embodiment; and

FIG. 11 illustrates a configuration of an NR base station according to an embodiment.

### DETAILED DESCRIPTION

The following description with reference to the accompanying drawings is provided to assist in a comprehensive understanding of embodiments of the present disclosure. Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

In the description, terms for identifying access nodes and referring to network entities, messages, interfaces between network entities, and identification information, are illustratively used for the sake of descriptive convenience. Therefore, the disclosure is not limited by the terms as used below, and other terms referring to subjects having equivalent technical meanings may be used.

Moreover, terms and names defined in the 3rd generation partnership project LTE (3GPP LTE) standards will be used for the sake of descriptive convenience. However, the disclosure is not limited by these terms and names, and may be similarly applied to systems that conform other standards. The term eNB may be interchangeably used with the term gNB for the sake of descriptive convenience. That is, a base station described as eNB may indicate gNB.

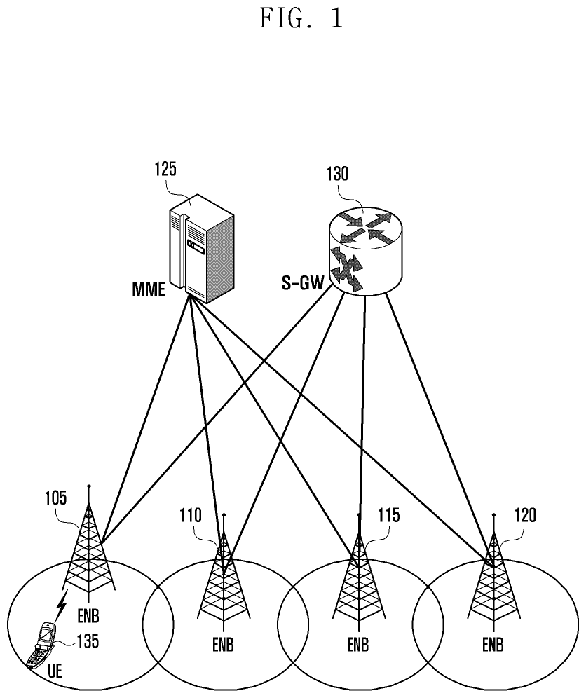

FIG. 1 illustrates a structure of an LTE system according to an embodiment.

Referring to FIG. 1, a radio access network of an LTE system includes next-generation base stations (evolved node Bs (ENBs), node Bs, or gNBs) 105, 110, 115, and 120, a mobility management entity (MME) 125, and a serving gateway (S-GW) 130. A UE (or terminal) 135 accesses an external network through the ENBs 105 to 120 and the S-GW 130.

In FIG. 1, the ENBs 105 to 120 each correspond to a conventional node B in a universal mobile telecommunications service (UMTS) system. The ENBs are connected to the UE 135 through a radio channel, and perform more complicated roles than the conventional node Bs. In the LTE system, since all user traffic including real-time services, such as voice over IP (VOIP) via the Internet protocol, is serviced through a shared channel, a device that collects state information, such as buffer states, available transmit power states, and channel states of UEs, and performs scheduling accordingly is required, and the ENBs 105 to 120 serve as the device. In general, one ENB controls multiple cells. For example, to implement a transfer rate of 100 megabits per second (Mbps), the LTE system uses orthogonal frequency division multiplexing (OFDM) as a radio access technology in a bandwidth of, for example, 20 MHz. The LTE system employs an adaptive modulation & coding (hereinafter AMC) scheme for determining a modulation scheme and a channel coding rate according to a channel state of the UE.

The S-GW 130 provides a data bearer, and generates or removes a data bearer under the control of the MME 125.

The MME is responsible for various control functions as well as a mobility management function for a UE, and is connected to multiple base stations.

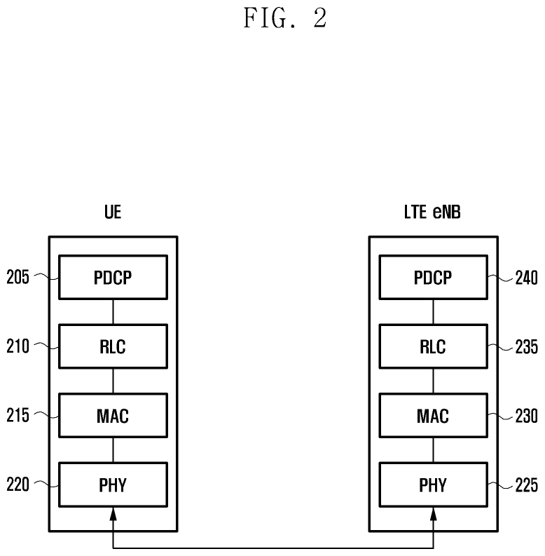

FIG. 2 illustrates a radio protocol structure of an LTE system according to an embodiment.

Referring to FIG. 2, a radio protocol of an LTE system includes a packet data convergence protocol (PDCP) 205 or 240, a radio link control (RLC) 210 or 235, and a medium access control (MAC) 215 or 230 in each of a UE and an ENB. The PDCP 205 or 240 serves to perform operations such as IP header compression/reconstruction. The main functions of the PDCP are robust header compression (ROHC) and decompression, transfer of user data, in-sequence delivery of upper layer protocol data units (PDUs) at PDCP re-establishment procedure for radio link control acknowledge mode (RLC AM), for split bearers in dual connectivity (DC) support for RLC AM and PDCP PDU routing for transmission and PDCP PDU reordering for reception, duplicate detection of lower layer service data units (SDUs) at a PDCP re-establishment procedure for RLC AM, retransmission of PDCP SDUs at handover and, for split bearers in DC, of PDCP PDUs at a PDCP data-recovery procedure for RLC AM, ciphering and deciphering, and timer-based SDU discard in the uplink.

The radio link control (hereinafter referred to as RLC) 210 or 235 reconfigures a PDCP protocol data unit (PDU) into an appropriate size to perform an automatic repeat request (ARQ) operation. The main functions of the RLC are the transfer of upper layer PDUs, error correction through ARQ for AM data transfer, concatenation, segmentation and reassembly of RLC SDUs for unacknowledged mode (UM) and AM data transfer, re-segmentation of RLC data PDUs for AM data transfer, reordering of RLC data PDUs for UM and AM data transfer, duplicate detection for UM and AM data transfer, protocol error detection for AM data transfer, RLC SDU discard for UM and AM data transfer, and RLC re-establishment.

The MAC 215 or 230 is connected to several RLC layer devices configured in a single UE, and multiplexes RLC PDUs to a MAC PDU and demultiplexes a MAC PDU to RLC PDUs. The main functions of the MAC are mapping between logical channels and transport channels, multiplexing/demultiplexing of MAC SDUs belonging to one or different logical channels into/from transport blocks (TBs) delivered to/from the physical layer on transport channels, scheduling information reporting, error correction through hybrid ARQ (HARQ), priority handling between logical channels of one UE, priority handling between UEs by dynamic scheduling, multimedia broadcast multicast service (MBMS) identification, transport format selection, and padding.

A physical layer 220 or 225 performs operations of channel-coding and modulating upper layer data, generating the same into OFDM symbols, and transmitting the same through a radio channel, or demodulating the OFDM symbols received through the radio channel, channel-decoding the same, and delivering the same to the upper layer.

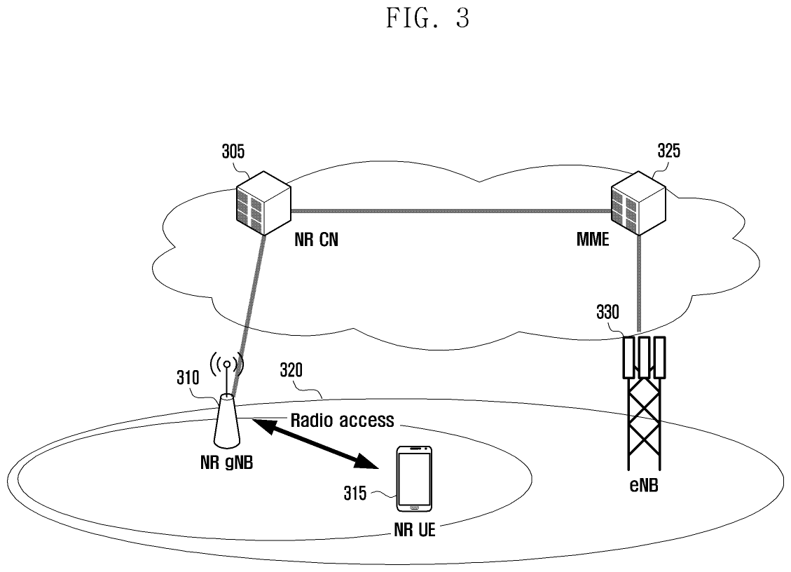

FIG. 3 illustrates a structure of a next-generation mobile communication system according to an embodiment.

Referring to FIG. 3, a radio access network of a NR or 5G system includes an NR gNB or NR base station 310, and a new radio core network (NR CN) 305. An NR UE or NR terminal 315 accesses an external network via the NR gNB 310 and the NR CN 305.

In FIG. 3, the NR gNB 310 corresponds to an ENB of a conventional LTE system. The NR gNB 310 is connected to the NR UE 315 through a radio channel, and can provide superior services as compared to a conventional node Bs. In the next-generation mobile communication system, since all user traffic is serviced through a shared channel, a device that collects state information, such as buffer statuses, available transmit power states, and channel states of UEs, and performs scheduling accordingly is required. The NR NB 310 serves as the device. One NR gNB generally controls multiple cells. To implement ultrahigh-speed data transfer beyond the current LTE, the next-generation mobile communication system may provide a wider bandwidth than the existing maximum bandwidth, may employ OFDM as a radio access technology, and may additionally integrate a beamforming technology therewith. The next-generation mobile communication system employs an adaptive modulation & coding (AMC) scheme for determining a modulation scheme and a channel coding rate according to a channel state of a UE.

The NR CN 305 performs functions such as mobility support, bearer configuration, and quality of service (QOS) configuration. The NR CN is responsible for various control functions as well as a mobility management function for a UE, and is connected to multiple base stations. The next-generation mobile communication system may interwork with the existing LTE system, and the NR CN is connected to an MME 325 via a network interface. The MME is connected to an eNB 330 that is a conventional base station.

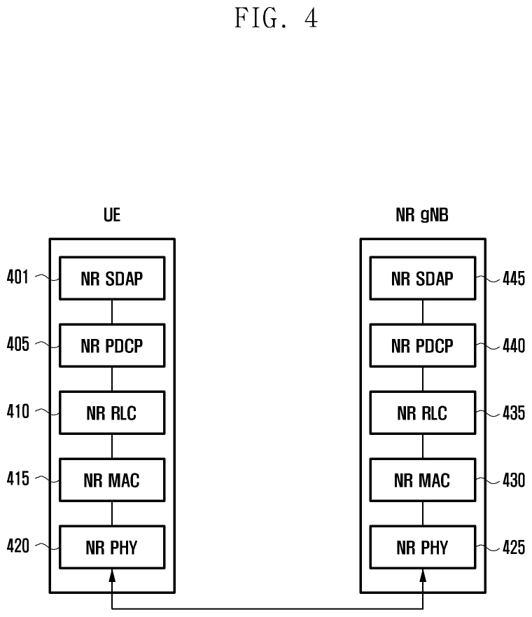

FIG. 4 illustrates a radio protocol structure of a next-generation mobile communication system according to an embodiment.

Referring to FIG. 4, a radio protocol of a next-generation mobile communication system includes an NR service data adaptation protocol (SDAP) 401 or 445, an NR PDCP 405 or 440, an NR RLC 410 or 435, and an NR MAC 415 or 430 in each of a UE and an NR base station.

The main functions of the NR SDAP 401 or 445 may include transfer of user plane data, mapping between a QoS flow and a data radio bearer (DRB) for both DL and UL, marking QoS flow identity (ID) in both DL and UL packets, and reflective QoS flow to DRB mapping for UL SDAP PDUs.

With regard to the SDAP layer device, the UE may be configured, through an RRC message, to use the header of the SDAP layer device or to use functions of the SDAP layer device for each PDCP layer device or each bearer or each logical channel. If an SDAP header is configured, the non-access stratum (NAS) QoS reflection configuration 1-bit indicator (NAS reflective QoS) and the access stratum (AS) QoS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority and scheduling information for smoothly supporting services.

The main functions of the NR PDCP 405 or 440 may include ROHC and decompression, transfer of user data, in-sequence delivery of upper layer PDUs, out-of-sequence delivery of upper layer PDUs, PDCP PDU reordering for reception, duplicate detection of lower layer SDUs, retransmission of PDCP SDUs, ciphering and deciphering, and timer-based SDU discard in the uplink.

The reordering of the NR PDCP device refers to reordering PDCP PDU received from a lower layer in an order based on PDCP sequence numbers (SNs), and may include a function of transferring data to an upper layer according to a rearranged order, directly transferring data without considering order, rearranging order to record lost PDCP PDUs, reporting the state of lost PDCP PDUs to a transmission side, or requesting retransmission of lost PDCP PDUs.

The main functions of the NR RLC 410 or 435 may include transfer of upper layer PDUs, in-sequence delivery of upper layer PDUs, out-of-sequence delivery of upper layer PDUs, error correction through ARQ, concatenation, segmentation and reassembly of RLC SDUs, re-segmentation of RLC data PDUs, reordering of RLC data PDUs, duplicate detection, protocol error detection, RLC SDU discard, and RLC re-establishment.

The in-sequence delivery of the NR RLC device refers to transferring RLC SDUs received from a lower layer to an upper layer in sequence, and may include a function of, if one original RLC SDU is divided into several RLC SDUs and then the RLC SDUs are received, reassembling the several RLC SDUs and transferring the reassembled RLC SDUs, rearranging received RLC PDUs with reference to RLC SNs or PDCP SNs, rearranging order to record lost RLC PDUs, reporting the state of lost RLC PDUs to a transmission side, requesting retransmission of lost RLC PDUs, sequentially transferring, if there is a lost RLC SDU, only RLC SDUs before the lost RLC SDU to an upper layer, although there is a lost RLC SDU, if a predetermined timer has expired, sequentially transferring, to an upper layer, all the RLC SDUs received before the timer is started, or although there is a lost RLC SDU, if a predetermined timer has expired, sequentially transferring all the RLC SDUs received up to the current, to an upper layer.

The RLC PDUs may be processed in the received order, regardless of the sequence number or arrival order, and delivered to the PDCP device regardless of the order. Segments which are stored in a buffer or are to be received later may be received, reconfigured into one complete RLC PDU, processed, and delivered to the PDCP device. The NR RLC layer may include no concatenation function, which may be performed in the NR MAC layer or replaced with a multiplexing function of the NR MAC layer.

The out-of-sequence delivery function of the NR RLC device refers to instantly delivering RLC SDUs received from the lower layer to the upper layer regardless of the order, and may include reassembling and delivering multiple RLC SDUs received, into which one original RLC SDU has been segmented, storing the RLC SN or PDCP SN of received RLC PDUs, and recording RLC PDUs lost as a result of reordering.

The NR MAC 415 or 430 may be connected to several NR RLC layer devices configured in a single UE, and the main functions of the NR MAC may include mapping between logical channels and transport channels, multiplexing/demultiplexing of MAC SDUs, scheduling information reporting, error correction through HARQ, priority handling between logical channels of one UE, priority handling between UEs by dynamic scheduling, MBMS service identification, transport format selection, and padding.

An NR PHY layer 420 or 425 may perform operations of channel-coding and modulating upper layer data, thereby obtaining OFDM symbols, and delivering the symbols through a radio channel, or demodulating OFDM symbols received through the radio channel, and channel-decoding and delivering the symbols to the upper layer.

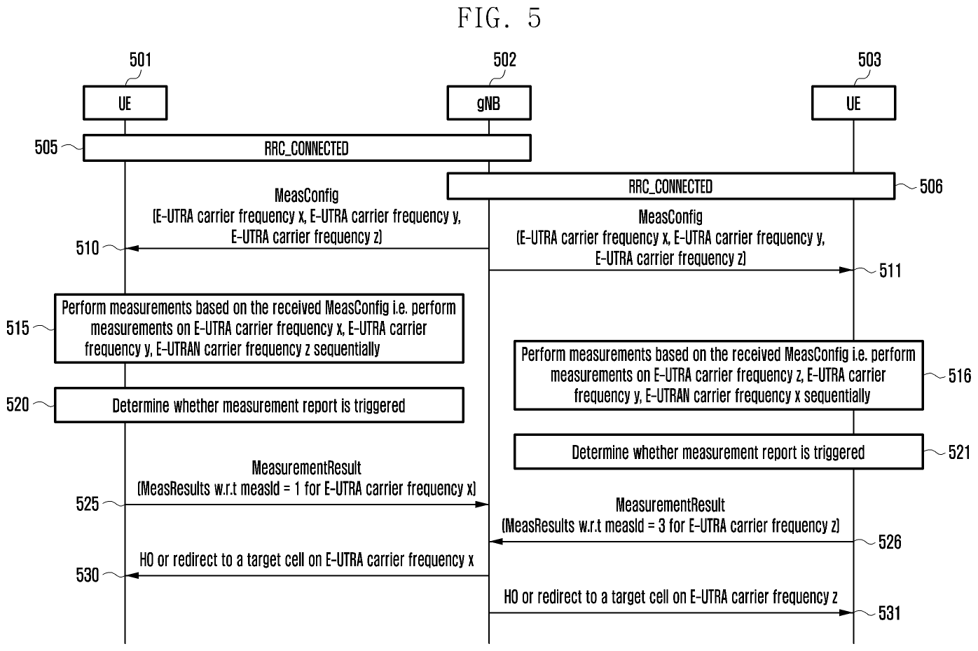

FIG. 5 illustrates a process in which a terminal transmits a measurement result message to a base station in a next generation mobile communication system according to an embodiment.

When measuring frequencies configured by a base station, a terminal measures the frequencies according to implementation of each terminal regardless of the intention of the base station. This may cause a situation where, even when a predetermined service such as voice over LTE (VOLTE) is optimally providable at a particular frequency, the service is provided to the terminal through a frequency other than the optimal frequency. Specifically, when the base station determines a frequency for providing the service to the terminal, the base station uses a measurement result message transmitted by the terminal.

More specifically, when a measurement result message is received from the terminal, the base station transmits, based on the reception and to the terminal, a predetermined handover message or an RRC connection release message containing RedirectedCarrierInfo indicating movement to a particular frequency, and the terminal moves to a particular target cell according to an RRC configuration of the base station. Wen the base station is to provide a VOLTE service to two terminals, the base station configures the same measurement configuration information (E-universal terrestrial radio access (UTRA) frequency x, E-UTRA frequency y, and E-UTRA frequency z) for the two terminals. A first terminal may first measure E-UTRA frequency x and then transmit a measurement result message based frequency x to the base station. A second terminal may first measure E-UTRA frequency z and then transmit a measurement result message based on frequency z to the base station. Even when E-UTRA frequency x is optimized to provide the VOLTE service, the base station may, based on the measurement result messages from the two terminals, instruct only the first terminal to move to a cell belonging to E-UTRA frequency x and instruct the second terminal to move to a cell belonging to E-UTRA frequency z.

Referring to FIG. 5, respective terminals 501 and 503 may establish RRC connections with an NR base station 502 to be in an RRC connected mode (RRC_CONNECTED) in steps 505 and 506.

The base station 502 may transmit an RRC message (e.g., RRCReconfiguration) including measurement configuration information (MeasConfig) to each terminal 501 or 503 in steps 510 and 511. The measurement configuration information may include at least one of measurement objects, reporting configurations, measurement identities, measurement filtering configuration information (quantity configurations), and measurement gap configuration information (measurement gaps), and description of each parameter described above is as defined in Table 1 below.

TABLE 1
1. Measurement objects: A list of objects on which the UE shall perform the measurements.
For intra-frequency and inter-frequency measurements a measurement object indicates the
frequency/time location and subcarrier spacing of reference signals to be measured. Associated with this
measurement object, the network may configure a list of cell specific offsets, a list of ‘exclude-listed’
cells and a list of ‘allow-listed’ cells. Exclude-listed cells are not applicable in event evaluation or
measurement reporting. Allow-listed cells are the only ones applicable in event evaluation or
measurement reporting.
The measObjectId of the MO which corresponds to each serving cell is indicated by
servingCellMO within the serving cell configuration.
For inter-radio access technology (RAT) E-UTRA measurements a measurement object is a
single E-UTRA carrier frequency. Associated with this E-UTRA carrier frequency, the network can
configure a list of cell specific offsets and a list of ‘exclude-listed’ cells. Exclude-listed cells are not
applicable in event evaluation or measurement reporting.
For inter-RAT UTRA-FDD measurements a measurement object is a set of cells on a single
UTRA-FDD carrier frequency.
For NR sidelink measurements of L2 U2N Relay UEs, a measurement object is a single NR
sidelink frequency to be measured.
For CBR measurement of NR sidelink communication, a measurement object is a set of
transmission resource pool(s) on a single carrier frequency for NR sidelink communication.
For CBR measurement of NR sidelink discovery, a measurement object is a set of discovery
dedicated resource pool(s) or transmission resource pool(s) also used for NR sidelink discovery on a
single carrier frequency for NR sidelink discovery.
For CLI measurements a measurement object indicates the frequency/time location of SRS
resources and/or CLI-RSSI resources, and subcarrier spacing of SRS resources to be measured.
2. Reporting configurations: A list of reporting configurations where there can be one or
multiple reporting configurations per measurement object. Each measurement reporting configuration
consists of the following:
Reporting criterion: The criterion that triggers the UE to send a measurement report. This can
either be periodical or a single event description.
RS type: The RS that the UE uses for beam and cell measurement results (SS/PBCH block or
CSI-RS).
Reporting format: The quantities per cell and per beam that the UE includes in the measurement
report (e.g. RSRP) and other associated information such as the maximum number of cells and the
maximum number beams per cell to report.
In case of conditional reconfiguration, each configuration consists of the following:
Execution criteria: The criteria the UE uses for conditional reconfiguration execution.
RS type: The RS that the UE uses for obtaining beam and cell measurement results (SS/PBCH
block-based or CSI-RS-based), used for evaluating conditional reconfiguration execution condition.
3. Measurement identities: For measurement reporting, a list of measurement identities where
each measurement identity links one measurement object with one reporting configuration. By
configuring multiple measurement identities, it is possible to link more than one measurement object to
the same reporting configuration, as well as to link more than one reporting configuration to the same
measurement object. The measurement identity is also included in the measurement report that triggered
the reporting, serving as a reference to the network. For conditional reconfiguration triggering, one
measurement identity links to exactly one conditional reconfiguration trigger configuration. And up to 2
measurement identities can be linked to one conditional reconfiguration execution condition.
4. Quantity configurations: The quantity configuration defines the measurement filtering
configuration used for all event evaluation and related reporting, and for periodical reporting of that
measurement. For NR measurements, the network may configure up to 2 quantity configurations with a
reference in the NR measurement object to the configuration that is to be used. In each configuration,
different filter coefficients can be configured for different measurement quantities, for different RS types,
and for measurements per cell and per beam.
5. Measurement gaps: Periods that the UE may use to perform measurements.

The base station 502 may provide measurement configuration information for measuring an intra-frequency to which a special cell (SpCell) corresponding to each terminal 501 or 503 belongs, an inter-frequency adjacent to the SpCell, and frequencies using a radio access technology (RAT) different from that of the SpCell. Specific information fields of such measurement configuration information may have an ASN.1 structure as shown in Table 2 below.

TABLE 2

| | |
|---|---|
| MeasConfig ::= | SEQUENCE { |
| measObjectToRemoveList | MeasObjectToRemoveList |
| OPTIONAL, -- Need N | |
| measObjectToAddModList | MeasObjectToAddModList |
| OPTIONAL, -- Need N | |
| reportConfigToRemoveList | ReportConfigToRemoveList |
| OPTIONAL, -- Need N | |
| reportConfigToAddModList | ReportConfigToAddModList |
| OPTIONAL, -- Need N | |
| measIdToRemoveList | MeasIdToRemoveList |
| OPTIONAL, -- Need N | |
| measIdToAddModList | MeasIdToAddModList |
| OPTIONAL, -- Need N | |
| s-MeasureConfig | CHOICE { |
| ssb-RSRP | RSRP-Range, |
| csi-RSRP | RSRP-Range |
| } | |
| OPTIONAL, -- Need M | |
| quantityConfig | QuantityConfig |
| OPTIONAL, -- Need M | |
| measGapConfig | MeasGapConfig |
| OPTIONAL, -- Need M | |
| measGapSharingConfig | MeasGapSharingConfig |
| OPTIONAL, -- Need M | |
| ..., | |
| [[ | |
| interFrequencyConfig-NoGap-r16 | ENUMERATED {true} |
| OPTIONAL -- Need R | |
| ]] | |
| } | |
| MeasObjectToRemoveList ::= | SEQUENCE (SIZE |

(1..maxNrofObjectId)) OF MeasObjectId

| | |
|---|---|
| MeasIdToRemoveList ::= | SEQUENCE (SIZE (1..maxNrofMeasId)) |
| OF MeasId | |
| ReportConfigToRemoveList ::= | SEQUENCE (SIZE |

(1..maxReportConfigId)) OF ReportConfigId

-- TAG-MEASCONFIG-STOP
-- ASN1STOP

MeasConfig field descriptions

interFrequencyConfig-NoGap-r16
If the field is set to true, UE is configured to perform SSB based inter-
frequency measurement without measurement gaps when the inter-
frequency SSB is completely contained in the active DL BWP of the UE,
as specified in TS 38.133 [14], clause 9.3. Otherwise, the SSB based inter-
frequency measurement is performed within measurement gaps. In
NR-DC, the field can only be configured in the measConfig associated
with MCG, and when configured, it applies to all the inter-frequency
measurements configured by MN and SN.
measGapConfig
Used to setup and release measurement gaps in NR.
measIdToAddModList
List of measurement identities to add and/or modify.
measIdToRemoveList
List of measurement identities to remove.
measObjectToAddModList
List of measurement objects to add and/or modify.
measObjectToRemoveList
List of measurement objects to remove.
reportConfigToAddModList
List of measurement reporting configurations to add and/or modify.
reportConfigToRemoveList
List of measurement reporting configurations to remove.
s-MeasureConfig
Threshold for NR SpCell RSRP measurement controlling when the UE is
required to perform measurements on non-serving cells. Choice of
ssb-RSRP corresponds to cell RSRP based on SS/PBCH block and choice
of csi-RSRP corresponds to cell RSRP of CSI-RS.
measGapSharingConfig
Specifies the measurement gap sharing scheme and controls setup/release
of measurement gap sharing.

For conciseness, it is presumed herein that the base station 502 configures three frequencies, that is, E-UTRA carrier frequency x, E-UTRA carrier frequency y, and E-UTRA carrier frequency z for the respective terminals 501 and 503 through the same measurement configuration information, and sequentially includes the three frequencies in MeasObjectToAddModList or MeasIdToAddModList to provide same. For example, each MeasObjectToAddMod included in MeasObjectToAddModList is configured by measObjectId and MeasObject, MeasObjectEUTRA (i.e., one of E-UTRA carrier frequency x, E-UTRA carrier frequency y, and E-UTRA carrier frequency z) may be configured as MeasObject, and MeasObjectToAddModList may sequentially include (measObjectId 1, E-UTRA carrier frequency x), (measObjectId 2, E-UTRA carrier frequency y), and (measObjectId 3 E-UTRA carrier frequency z). For example, each MeasIdToAddMod included in MeasIdToAddModList is configured by measId, measObjectId, and reportConfigId, and MeasIdToAddModList may sequentially include (measId 1, measObjectId1, reportConfigId 1), (measId 2, measObjectId2, reportConfigId2), and (measId 3, measObjectId3, reportConfigId3).

Each terminal 501 or 503 may perform measurement, based on the measurement configuration information received from the base station 502 in steps 515 and 516. A sequence in which each terminal 501 or 503 according to the disclosure measures the configured frequencies may differ according to implementation of each terminal. For example, the terminal 501, hereinafter, first terminal, may perform measurement in a sequence in which measObjects are included in MeasObjectToAddModList configured in MeasConfig (i.e., a sequence of E-UTRA frequency x, E-UTRA frequency y, and E-UTRA frequency z) in step 515. The terminal 503, hereinafter, a second terminal, may perform measurement in a sequence reverse to the sequence in which measObjects are included in MeasObjectToAddModList configured in MeasConfig (i.e., a sequence of E-UTRA frequency z, E-UTRA frequency y, and E-UTRA frequency x) in step 516. Each terminal 501 or 503 may perform measurement by applying measurement gap configuration information (measGapConfig) received in the measurement configuration information, or may perform measurement without measurement gap configuration information (e.g., when interFrequencyConfig-NoGap is configured and an inter-frequency synchronization signal block (SSB) belongs to an active downlink bandwidth part of the terminal). Each terminal 501 or 503 may perform a measurement operation through a procedure described in Table 3 below.

TABLE 3

| | |
|---|---|
| 1> | whenever the UE has a measConfig, perform RSRP and RSRQ measurements for each serving |
| | cell for which servingCellMO is configured as follows: |

| | |
|---|---|
| 2> | if the reportConfig associated with at least one measId included in the measIdList within |
| | VarMeasConfig contains an rsType set to ssb and ssb-ConfigMobility is configured in the |
| | measObject indicated by the servingCellMO: |

| | |
|---|---|
| 3> | if the reportConfig associated with at least one measId included in the measIdList within |
| | VarMeasConfig contains a reportQuantityRS-Indexes and maxNrofRS-IndexesToReport |
| | and contains an rsType set to ssb: |

| | |
|---|---|
| 4> | derive layer 3 filtered RSRP and RSRQ per beam for the serving cell based on |
| | SS/PBCH block, as described in 5.5.3.3a; |

| | |
|---|---|
| 3> | derive serving cell measurement results based on SS/PBCH block, as described in |
| | 5.5.3.3; |

| | |
|---|---|
| 2> | if the reportConfig associated with at least one measId included in the measIdList within |
| | VarMeasConfig contains an rsType set to csi-rs and CSI-RS-ResourceConfigMobility is |
| | configured in the measObject indicated by the servingCellMO: |

| | |
|---|---|
| 3> | if the reportConfig associated with at least one measId included in the measIdList within |
| | VarMeasConfig contains a reportQuantityRS-Indexes and maxNrofRS-IndexesToReport |
| | and contains an rsType set to csi-rs: |

| | |
|---|---|
| 4> | derive layer 3 filtered RSRP and RSRQ per beam for the serving cell based on CSI- |
| | RS, as described in 5.5.3.3a; |

| | |
|---|---|
| 3> | derive serving cell measurement results based on CSI-RS, as described in 5.5.3.3; |

| | |
|---|---|
| 1> | for each serving cell for which servingCellMO is configured, if the reportConfig associated |
| | with at least one measId included in the measIdList within VarMeasConfig contains SINR as |
| | trigger quantity and/or reporting quantity: |

| | |
|---|---|
| 2> | if the reportConfig contains rsType set to ssb and ssb-ConfigMobility is configured in the |
| | servingCellMO: |

| | |
|---|---|
| 3> | if the reportConfigcontains a reportQuantityRS-Indexes and maxNrofRS- |
| | Indexes ToReport: |

| | |
|---|---|
| 4> | derive layer 3 filtered SINR per beam for the serving cell based on SS/PBCH block, |
| | as described in 5.5.3.3a; |

| | |
|---|---|
| 3> | derive serving cell SINR based on SS/PBCH block, as described in 5.5.3.3; |

| | |
|---|---|
| 2> | if the reportConfig contains rsType set to csi-rs and CSI-RS-ResourceConfigMobility is |
| | configured in the servingCellMO: |

| | |
|---|---|
| 3> | if the reportConfigcontains a reportQuantityRS-Indexes and maxNrofRS- |
| | IndexesToReport: |

| | |
|---|---|
| 4> | derive layer 3 filtered SINR per beam for the serving cell based on CSI-RS, as |
| | described in 5.5.3.3a; |

| | |
|---|---|
| 3> | derive serving cell SINR based on CSI-RS, as described in 5.5.3.3; |

| | |
|---|---|
| 1> | for each measId included in the measIdList within VarMeasConfig: |

| | |
|---|---|
| 2> | if the reportType for the associated reportConfig is set to reportCGI and timer T321 is |
| | running: |

| | |
|---|---|
| 3> | if useAutonomousGaps is configured for the associated reportConfig: |

| | |
|---|---|
| 4> | perform the corresponding measurements on the frequency and RAT indicated in the |
| | associated measObject using autonomous gaps as necessary; |

| | |
|---|---|
| 3> | else: |

| | |
|---|---|
| 4> | perform the corresponding measurements on the frequency and RAT indicated in the |
| | associated measObject using available idle periods; |

| | |
|---|---|
| 3> | if the cell indicated by reportCGI field for the associated measObject is an NR cell and |
| | that indicated cell is broadcasting SIB1 (see TS 38.213 , clause 13): |

| | |
|---|---|
| 4> | try to acquire SIB1 in the concerned cell; |

| | |
|---|---|
| 3> | if the cell indicated by reportCGI field is an E-UTRA cell: |

| | |
|---|---|
| 4> | try to acquire SystemInformationBlockType1 in the concerned cell; |

| | |
|---|---|
| 2> | if the ul-DelayValueConfig is configured for the associated reportConfig: |

| | |
|---|---|
| 3> | ignore the measObject; |
| 3> | for each of the configured DRBs, configure the PDCP layer to perform corresponding |
| | average UL PDCP packet delay measurement per DRB; |

| | |
|---|---|
| 2> | if the ul-ExcessDelayConfig is configured for the associated reportConfig: |

| | |
|---|---|
| 3> | ignore the measObject; |
| 3> | for each of the configured DRBs, configure the PDCP layer to perform corresponding |
| | UL PDCP Excess Packet Delay delay measurement according to the configured |
| | threshold per DRB; |

| | |
|---|---|
| 2> | if the reportType for the associated reportConfig is periodical, eventTriggered; or |
| 2> | if the reportType for the associated reportConfig is condTriggerConfig, the measId is within |
| | the MCG measConfig and is indicated in the condExecutionCond associated to a |
| | condReconfigId in the MCG VarConditionalReconfig (for CHO, CPA or MN-initiated inter- |
| | SN CPC in NR-DC); or |
| 2> | if the reportType for the associated reportConfig is condTriggerConfig, the measId is within |
| | the SCG VarMeasConfig and is indicated in the condExecutionCond associated to a |
| | condReconfigId in the SCG VarConditionalReconfig (for intra-SN CPC); or |
| 2> | if the reportType for the associated reportConfig is condTriggerConfig, the measId is within |
| | the SCG VarMeasConfig and is indicated in the condExecutionCondSCG associated to a |
| | condReconfigId in the MCG VarConditionalReconfig (for SN-initiated inter-SN CPC in NR- |
| | DC); or |
| 2> | if the reportType for the associated reportConfig is condTriggerConfig, the measId is within |
| | the SCG VarMeasConfig and is indicated in the triggerConditionSN associated to a |
| | condReconfigurationId in VarConditionalReconfiguration as specified in TS 36.331 [10] |
| | (for SN-initiated inter-SN CPC in EN-DC): |

| | |
|---|---|
| 3> | if a measurement gap configuration is setup, or |
| 3> | if the UE does not require measurement gaps to perform the concerned measurements: |

| | |
|---|---|
| 4> | if s-MeasureConfig is not configured, or |
| 4> | if s-MeasureConfig is set to ssb-RSRP and the NR SpCell RSRP based on SS/PBCH |
| | block, after layer 3 filtering, is lower than ssb-RSRP, or |
| 4> | if s-MeasureConfig is set to csi-RSRP and the NR SpCell RSRP based on CSI-RS, |
| | after layer 3 filtering, is lower than csi-RSRP: |

| | |
|---|---|
| 5> | if the measObject is associated to NR and the rsType is set to csi-rs: |

| | |
|---|---|
| 6> | if reportQuantityRS-Indexes and maxNrofRS-IndexesToReport for the |
| | associated reportConfig are configured: |

| | |
|---|---|
| 7> | derive layer 3 filtered beam measurements only based on CSI-RS for each |
| | measurement quantity indicated in reportQuantityRS-Indexes, as described |
| | in 5.5.3.3a; |

| | |
|---|---|
| 6> | derive cell measurement results based on CSI-RS for the trigger quantity and |
| | each measurement quantity indicated in reportQuantityCell using parameters |
| | from the associated measObject, as described in 5.5.3.3; |

| | |
|---|---|
| 5> | if the measObject is associated to NR and the rsType is set to ssb: |

| | |
|---|---|
| 6> | if reportQuantityRS-Indexes and maxNrofRS-IndexesToReport for the |
| | associated reportConfig are configured: |

| | |
|---|---|
| 7> | derive layer 3 beam measurements only based on SS/PBCH block for each |
| | measurement quantity indicated in reportQuantityRS-Indexes, as described |
| | in 5.5.3.3a; |

| | |
|---|---|
| 6> | derive cell measurement results based on SS/PBCH block for the trigger |
| | quantity and each measurement quantity indicated in reportQuantityCell using |
| | parameters from the associated measObject, as described in 5.5.3.3; |

| | |
|---|---|
| 5> | if the measObject is associated to E-UTRA: |

| | |
|---|---|
| 6> | perform the corresponding measurements associated to neighbouring cells on |
| | the frequencies indicated in the concerned measObject, as described in |
| | 5.5.3.2; |

| | |
|---|---|
| 5> | if the measObject is associated to UTRA-FDD: |

| | |
|---|---|
| 6> | perform the corresponding measurements associated to neighbouring cells on |
| | the frequencies indicated in the concerned measObject, as described in |
| | 5.5.3.2; |

| | |
|---|---|
| 5> | if the measObject is associated to L2 U2N Relay UE: |

| | |
|---|---|
| 6> | perform the corresponding measurements associated to candidate Relay UEs |
| | on the frequencies indicated in the concerned measObject, as described in |
| | 5.5.3.4; |

| | |
|---|---|
| 4> | if the measRSSI-ReportConfig is configured in the associated reportConfig: |

| | |
|---|---|
| 5> | perform the RSSI and channel occupancy measurements on the frequency |
| | indicated in the associated measObject, |

| | |
|---|---|
| NOTE 0: | The network avoids configuring UEs supporting only CHO and/or Rel-16 CPC with |

measurements not referred to by any execution condition.

| | |
|---|---|
| 2> | if the reportType for the associated reportConfig is set to reportSFTD and the |
| | numberOfReportsSent as defined within the VarMeasReportList for this measId is less than |
| | one: |

| | |
|---|---|
| 3> | if the reportSFTD-Meas is set to true: |

| | |
|---|---|
| 4> | if the measObject is associated to E-UTRA: |

| | |
|---|---|
| 5> | perform SFTD measurements between the PCell and the E-UTRA PSCell; |
| 5> | if the reportRSRP is set to true; |

| | |
|---|---|
| 6> | perform RSRP measurements for the E-UTRA PSCell; |

| | |
|---|---|
| 4> | else if the measObject is associated to NR: |

| | |
|---|---|
| 5> | perform SFTD measurements between the PCell and the NR PSCell; |
| 5> | if the reportRSRP is set to true; |

| | |
|---|---|
| 6> | perform RSRP measurements for the NR PSCell based on SSB; |

| | |
|---|---|
| 3> | else if the reportSFTD-NeighMeas is included: |

| | |
|---|---|
| 4> | if the measObject is associated to NR: |

| | |
|---|---|
| 5> | if the drx-SFTD-NeighMeas is included: |

| | |
|---|---|
| 6> | perform SFTD measurements between the PCell and the NR neighbouring |
| | cell(s) detected based on parameters in the associated measObject using |
| | available idle periods; |

| | |
|---|---|
| 5> | else: |

| | |
|---|---|
| 6> | perform SFTD measurements between the PCell and the NR neighbouring |
| | cell(s) detected based on parameters in the associated measObject, |

| | |
|---|---|
| 5> | if the reportRSRP is set to true: |

| | |
|---|---|
| 6> | perform RSRP measurements based on SSB for the NR neighbouring cell(s) |
| | detected based on parameters in the associated measObject, |

| | |
|---|---|
| 2> | if the reportType for the associated reportConfig is cli-Periodical or cli-EventTriggered: |

| | |
|---|---|
| 3> | perform the corresponding measurements associated to CLI measurement resources |
| | indicated in the concerned measObjectCLI; |

| | |
|---|---|
| 2> | perform the evaluation of reporting criteria as specified in 5.5.4, except if reportConfig is |
| | condTriggerConfig. |

The UE acting as a L2 U2N Remote UE whenever configured with measConfig shall:

| | |
|---|---|
| 1> | perform the corresponding measurements associated to the serving L2 U2N Relay UE, as |
| | described in 5.5.3.4; |

| | |
|---|---|
| NOTE 1: | The evaluation of conditional reconfiguration execution criteria is specified in 5.3.5.13. |

The UE capable of Rx-Tx time difference measurement when configured with measObjectRxTxDiff
shall:

| | |
|---|---|
| 1> | perform the corresponding Rx-Tx time difference measurements associated with downlink |
| | reference signals indicated in the concerned measObjectRxTxDiff. |

The UE capable of CBR measurement when configured to transmit NR sidelink
communication/discovery shall:

| | |
|---|---|
| 1> | If the frequency used for NR sidelink communication/discovery is included in sl- |
| | FreqInfoToAddModList in sl-ConfigDedicatedNR within RRCReconfiguration message or |
| | included in sl-ConfigCommonNR within SIB12: |

| | |
|---|---|
| 2> | if the UE is in RRC_IDLE or in RRC_INACTIVE: |

| | |
|---|---|
| 3> | if configured with NR sidelink communication and the cell chosen for NR sidelink |
| | communication provides SIB12 which includes sl-TxPoolSelectedNormal or sl- |
| | TxPoolExceptional for the concerned frequency; or |
| 3> | if configured with NR sidelink discovery and the cell chosen for NR sidelink discovery |
| | provides SIB12 which includes sl-TxPoolSelectedNormal or sl-TxPoolExceptional but |
| | does not include sl-DiscTxPoolSelected for the concerned frequency: |

| | |
|---|---|
| 4> | perform CBR measurement on pool(s) in sl-TxPoolSelectedNormal or sl- |
| | TxPoolExceptional for the concerned frequency in SIB12; |

| | |
|---|---|
| 3> | if configured with NR sidelink discovery and the cell chosen for NR sidelink discovery |
| | provides SIB12 which includes sl-DiscTxPoolSelected for the concerned frequency: |

| | |
|---|---|
| 4> | perform CBR measurement on pools in sl-DiscTxPoolSelected and sl- |
| | TxPoolExceptional for the concerned frequency in SIB12; |

| | |
|---|---|
| 2> | if the UE is in RRC_CONNECTED: |

| | |
|---|---|
| 3> | if tx-PoolMeasToAddModList is included in VarMeasConfig: |

| | |
|---|---|
| 4> | perform CBR measurements on each transmission resource pool indicated in the tx- |
| | PoolMeasToAddModList; |

| | |
|---|---|
| 3> | if sl-DiscTxPoolSelected, sl-TxPoolSelectedNormal, sl-TxPoolScheduling or sl- |
| | TxPoolExceptional is included in sl-ConfigDedicatedNR for the concerned frequency |
| | within RRCReconfiguration: |

| | |
|---|---|
| 4> | perform CBR measurement on pool(s) in sl-DiscTxPoolSelected, sl- |
| | TxPoolSelectedNormal, sl-TxPoolScheduling and sl-TxPoolExceptional if included in |
| | sl-ConfigDedicatedNR for the concerned frequency within RRCReconfiguration; |

| | |
|---|---|
| 3> | else: |

| | |
|---|---|
| 4> | if configured with NR sidelink communication and the cell chosen for NR sidelink |
| | communication provides SIB12 which includes sl-TxPoolSelectedNormal or sl- |
| | TxPoolExceptional for the concerned frequency; or |
| 4> | if configured with NR sidelink discovery and the cell chosen for NR sidelink |
| | discovery provides SIB12 which includes sl-TxPoolSelectedNormal or sl- |
| | TxPoolExceptional but does not provide sl-DiscTxPoolSelected for the concerned |
| | frequency: |

| | |
|---|---|
| 5> | perform CBR measurement on pool(s) in sl-TxPoolSelectedNormal or sl- |
| | TxPoolExceptional for the concerned frequency in SIB12; |

| | |
|---|---|
| 4> | if configured with NR sidelink discovery and the cell chosen for NR sidelink |
| | discovery provides SIB12 which includes sl-DiscTxPoolSelected for the concerned |
| | frequency: |

| | |
|---|---|
| 5> | perform CBR measurement on pools in sl-DiscTxPoolSelected and sl- |
| | TxPoolExceptional for the concerned frequency in SIB12; |

| | |
|---|---|
| 1> | else: |

| | |
|---|---|
| 2> | if configured with NR sidelink communication and sl-TxPoolSelectedNormal is included in |
| | SidelinkPreconfigNR for the concerned frequency; or |
| 2> | if configured with NR sidelink discovery and sl-TxPoolSelectedNormal is included in |
| | SidelinkPreconfigNR but sl-DiscTxPoolSelected is not included in SidelinkPreconfigNR for |
| | the concerned frequency: |

| | |
|---|---|
| 3> | perform CBR measurement on pool(s) in sl-TxPoolSelectedNormal in |
| | SidelinkPreconfigNR for the concerned frequency. |

| | |
|---|---|
| 2> | if configured with NR sidelink discovery and sl-DiscTxPoolSelected is included in |
| | SidelinkPreconfigNR for the concerned frequency: |

| | |
|---|---|
| 3> | perform CBR measurement on pools in sl-DiscTxPoolSelected if included in |
| | SidelinkPreconfigNR. |

| NOTE 2: | In case the configurations for NR sidelink communication and CBR measurement are |
|---|---|
| | acquired via the E-UTRA, configurations for NR sidelink communication in SIB12, sl- |
| | ConfigDedicatedNR within RRCReconfiguration used in this clause are provided by the |
| | configurations in SystemInformationBlockType 28, sl-ConfigDedicatedForNR within |
| | RRCConnectionReconfiguration as specified in TS 36.331[10], respectively. |
| NOTE 3: | If a UE that is configured by upper layers to transmit V2X sidelink communication is |
| | configured by NR with transmission resource pool(s) and the measurement objects |
| | concerning V2X sidelink communication (i.e. by sl-ConfigDedicatedEUTRA-Info), it |
| | shall perform CBR measurement as specified in clause 5.5.3 of TS 36.331 [10], based on |
| | the transmission resource pool(s) and the measurement object(s) concerning V2X |
| | sidelink communication configured by NR. |
| NOTE 4: | For V2X sidelink communication, each of the CBR measurement results is associated |

with a resource pool, as indicated by the poolReportId (see TS 36.331 [10]), that refers
to a pool as included in sl-ConfigDedicatedEUTRA-Info or SIB13.

When each terminal performs measurement through the above procedure, a method (layer 3 filtering) of performing layer 3 filtering may follow the procedure described in Table 4 below, a method (derivation of cell measurement results) of deriving a cell measurement result may follow a procedure described in Table 5 below, and a method (derivation of layer 3 beam filtered measurement) of deriving a layer 3 beam-filtered measurement result may follow a procedure described in Table 6 below.

TABLE 4

| | |
|---|---|
| 5.5.3.2 | Layer 3 filtering |

The UE shall:

| 1> | for each cell measurement quantity, each beam measurement quantity, each sidelink | |
|---|---|---|
| | measurement quantity as needed in clause 5.8.10, for each CLI measurement quantity that the | |
| | UE performs measurements according to 5.5.3.1, and for each candidate L2 U2N Relay UE | |
| | measurement quantity according to 5.5.3.4: | |
| | 2> | filter the measured result, before using for evaluation of reporting criteria or for |
| | | measurement reporting, by the following formula: |
| | Fₙ = (1 − a)*Fₙ₋₁ + a*Mₙ | |
| | | where |
| | | Mₙ is the latest received measurement result from the physical layer; |
| | | Fₙ is the updated filtered measurement result, that is used for evaluation of reporting |
| | | criteria or for measurement reporting; |
| | | Fₙ₋₁ is the old filtered measurement result, where F₀ is set to M₁ when the first |
| | | measurement result from the physical layer is received; and for MeasObjectNR, a = |
| | | ½^{(ki/4)}, where kᵢ is the filterCoefficient for the corresponding measurement quantity |
| | | of the i:th QuantityConfigNR in quantityConfigNR-List, and i is indicated by |
| | | quantityConfigIndex in MeasObjectNR; for other measurements, a = ½^{(k/4)}, where k |
| | | is the filterCoefficient for the corresponding measurement quantity received by the |
| | | quantityConfig; for UTRA-FDD, a = ½^{(k/4)}, where k is the filterCoefficient for the |
| | | corresponding measurement quantity received by quantityConfigUTRA-FDD in the |
| | | QuantityConfig; |
| | 2> | adapt the filter such that the time characteristics of the filter are preserved at different input |

rates, observing that the filterCoefficient k assumes a sample rate equal to X ms; The value
of X is equivalent to one intra-frequency L1 measurement period as defined in TS 38.133
[14] assuming non-DRX operation, and depends on frequency range.

| | |
|---|---|
| NOTE 1: | If k is set to 0, no layer 3 filtering is applicable. |
| NOTE 2: | The filtering is performed in the same domain as used for evaluation of reporting criteria |
| | or for measurement reporting, i.e., logarithmic filtering for logarithmic measurements. |
| NOTE 3: | The filter input rate is implementation dependent, to fulfil the performance requirements |
| | set in TS 38.133 [14]. For further details about the physical layer measurements, see TS |
| | 38.133 [14]. |
| NOTE 4: | For CLI-RSSI measurement, it is up to UE implementation whether to reset filtering |
| | upon BWP switch. |

TABLE 5

| | |
|---|---|
| 5.5.3.3 | Derivation of cell measurement results |

The network may configure the UE in RRC_CONNECTED to derive RSRP, RSRQ and SINR
measurement results per cell associated to NR measurement objects based on parameters configured in
the measObject (e.g. maximum number of beams to be averaged and beam consolidation thresholds)
and in the reportConfig (rsType to be measured, SS/PBCH block or CSI-RS).
The network may configure the UE in RRC_IDLE or in RRC_INACTIVE to derive RSRP and RSRQ
measurement results per cell associated to NR carriers based on parameters configured in
measIdleCarrierListNR within VarMeasIdleConfig for measurements performed according to 5.7.8.2a.
The UE shall:

| 1> | for each cell measurement quantity to be derived based on SS/PBCH block: | |
|---|---|---|
| | 2> | if nrofSS-BlocksToAverage is not configured in the associated measObject in |
| | | RRC_CONNECTED or in the associated entry in measIdleCarrierListNR within |
| | | VarMeasIdleConfig in RRC_IDLE/RRC_INACTIVE; or |
| | 2> | if absThreshSS-BlocksConsolidation is not configured in the associated measObject in |
| | | RRC_CONNECTED or in the associated entry in measIdleCarrierListNR within |
| | | VarMeasIdleConfig in RRC_IDLE/RRC_INACTIVE; or |
| | 2> | if the highest beam measurement quantity value is below or equal to absThreshSS- |

| BlocksConsolidation: | |
|---|---|
| 3> | derive each cell measurement quantity based on SS/PBCH block as the highest beam |

measurement quantity value, where each beam measurement quantity is described in TS
38.215 [9];

| | |
|---|---|
| 2> | else: |

| | |
|---|---|
| 3> | derive each cell measurement quantity based on SS/PBCH block as the linear power |

scale average of the highest beam measurement quantity values above absThreshSS-
BlocksConsolidation where the total number of averaged beams shall not exceed nrofSS-
BlocksToAverage, and where each beam measurement quantity is described in TS 38.215
[9];

| | 2> | if in RRC_CONNECTED, apply layer 3 cell filtering as described in 5.5.3.2; |
|---|---|---|
| 1> | for each cell measurement quantity to be derived based on CSI-RS: | |
| | 2> | consider a CSI-RS resource to be applicable for deriving cell measurements when the |
| | | concerned CSI-RS resource is included in the csi-rs-CellMobility including the physCellId |
| | | of the cell in theCSI-RS-ResourceConfigMobility in the associated measObject; |
| | 2> | if nrofCSI-RS-ResourcesToAverage in the associated measObject is not configured; or |
| | 2> | if absThreshCSI-RS-Consolidation in the associated measObject is not configured; or |
| | 2> | if the highest beam measurement quantity value is below or equal to absThreshCSI-RS- |
| | | Consolidation: |

| | |
|---|---|
| 3> | derive each cell measurement quantity based on applicable CSI-RS resources for the cell |
| | as the highest beam measurement quantity value, where each beam measurement |
| | quantity is described in TS 38.215 [9]; |

| | |
|---|---|
| 2> | else: |

| | |
|---|---|
| 3> | derive each cell measurement quantity based on CSI-RS as the linear power scale |
| | average of the highest beam measurement quantity values above absThreshCSI-RS- |
| | Consolidation where the total number of averaged beams shall not exceed nrofCSI-RS- |
| | ResourcesToAverage; |

| | |
|---|---|
| 2> | apply layer 3 cell filtering as described in 5.5.3.2. |

TABLE 6

| | |
|---|---|
| 5.5.3.3a | Derivation of layer 3 beam filtered measurement |

The UE shall:

| | |
|---|---|
| 1> | for each layer 3 beam filtered measurement quantity to be derived based on |
| | SS/PBCH block; |

| | |
|---|---|
| 2> | derive each configured beam measurement quantity based on |
| | SS/PBCH block as described in TS 38.215[9], and apply layer 3 beam |
| | filtering as described in 5.5.3.2; |

| | |
|---|---|
| 1> | for each layer 3 beam filtered measurement quantity to be derived based on |
| | CSI-RS; |

| | |
|---|---|
| 2> | derive each configured beam measurement quantity based on CSI-RS |
| | as described in TS 38.215 [9], and apply layer 3 beam filtering as |
| | described in 5.5.3.2. |

In step 520, the first terminal 501 may determine, based on a result of the measurement in step 515, whether a condition for reporting a measurement result message (MeasurementReport) to the base station 502 is satisfied, that is, whether the reporting is triggered. Similarly, in step 521, the second terminal 503 may determine, based on a result of the measurement in step 516, whether a condition for reporting a measurement result message (MeasurementReport) to the base station 502 is triggered.

A condition for triggering the measurement reporting, determined by each terminal 501 or 503, may be an event-based or a periodic condition. For example, the measurement configuration information transmitted in step 510 or step 511 includes one or multiple measObjectIds, reportConfigIds, and measIds, and each measId is mapped to a particular measObject and a particular reportConfig. Therefore, each terminal 501 or 503 determines whether a reporting condition (criterion) specified in a particular reportConfig is satisfied, and if the condition is satisfied, may transmit, to the base station 502, a measurement result reporting message (MeasurementReport) including a measId mapped to the reportConfig and a measurement result associated with the measId. More specifically, a procedure of determining whether each terminal 501 or 503 is triggered to report a measurement result is defined in Table 7 below.

TABLE 7

| | |
|---|---|
| 5.5.4 | Measurement report triggering |
| 5.5.4.1 | General |

If AS security has been activated successfully, the UE shall:

| 1> | for each measId included in the measIdList within VarMeasConfig: | |
|---|---|---|
| | 2> | if the corresponding reportConfig includes a reportType set to eventTriggered |

| or periodical: | |
|---|---|
| 3> | if the corresponding measObject concerns NR: |

| | |
|---|---|
| 4> | if the corresponding reportConfig includes measRSSI-ReportConfig: |

| | |
|---|---|
| 5> | consider the resource indicated by the rmtc-Config on the associated |

frequency to be applicable;

| | |
|---|---|
| 4> | if the eventAl or eventA2 is configured in the corresponding |

| reportConfig: | |
|---|---|
| 5> | consider only the serving cell to be applicable; |

| | |
|---|---|
| 4> | if the eventA3 or eventA5 is configured in the corresponding |

| reportConfig: | |
|---|---|
| 5> | if a serving cell is associated with a measObjectNR and neighbours |

are associated with another measObjectNR, consider any serving cell
associated with the other measObjectNR to be a neighbouring cell as
well;

| | |
|---|---|
| 4> | if the eventX2 is configured in the corresponding reportConfig: |

| | |
|---|---|
| 5> | consider only the serving L2 U2N Relay UE to be applicable; |

| | |
|---|---|
| 4> | if corresponding reportConfig includes reportType set to periodical; or |
| 4> | for measurement events other than eventA1, eventA2, eventD1 or |

| eventX2: | |
|---|---|
| 5> | if use AllowedCellList is set to true: |

| | |
|---|---|
| 6> | consider any neighbouring cell detected based on parameters in |

the associated measObjectNR to be applicable when the concerned
cell is included in the allowedCellsToAddModList defined within
the VarMeasConfig for this measId;

| | |
|---|---|
| 5> | else: |

| | |
|---|---|
| 6> | consider any neighbouring cell detected based on parameters in |

the associated measObjectNR to be applicable when the concerned
cell is not included in the excludedCellsToAddModList defined
within the VarMeasConfig for this measId;

| | |
|---|---|
| 3> | else if the corresponding measObject concerns E-UTRA: |

| | |
|---|---|
| 4> | if eventB1 or eventB2 is configured in the corresponding reportConfig: |

| | |
|---|---|
| 5> | consider a serving cell, if any, on the associated E-UTRA frequency |

as neighbour cell;

| | |
|---|---|
| 4> | consider any neighbouring cell detected on the associated frequency to |

be applicable when the concerned cell is not included in the
excludedCellsToAddModListEUTRAN defined within the
VarMeasConfig for this measId;

| | |
|---|---|
| 3> | else if the corresponding measObject concerns UTRA-FDD: |

| 4> | if eventB1-UTRA-FDD or eventB2-UTRA-FDD is configured in the |
|---|---|
| | corresponding reportConfig; or |
| 4> | if corresponding reportConfig includes reportType set to periodical: |

| | |
|---|---|
| 5> | consider a neighbouring cell on the associated frequency to be |

applicable when the concerned cell is included in the
cellsToAddModList defined within the VarMeasConfig for this
measId;

| | |
|---|---|
| 3> | else if the corresponding measObject concerns L2 U2N Relay UE: |

| 4> | if eventY1-Relay or eventY2-Relay is configured in the corresponding |
|---|---|
| | reportConfig; or |
| 4> | if corresponding reportConfig includes reportType set to periodical: |

| | |
|---|---|
| 5> | consider any L2 U2N Relay UE fulfilling upper layer criteria |

detected on the associated frequency to be applicable for this measId;

| | |
|---|---|
| 2> | else if the corresponding reportConfig includes a reportType set to reportCGI: |

| | |
|---|---|
| 3> | consider the cell detected on the associated measObject which has a |

physical cell identity matching the value of the cellForWhichToReportCGI
included in the corresponding reportConfig within the VarMeasConfig to
be applicable;

| | |
|---|---|
| 2> | else if the corresponding reportConfig includes a reportType set to |

| reportSFTD: | |
|---|---|
| 3> | if the corresponding measObject concerns NR: |

| | |
|---|---|
| 4> | if the reportSFTD-Meas is set to true: |

| | |
|---|---|
| 5> | consider the NR PSCell to be applicable; |

| | |
|---|---|
| 4> | else if the reportSFTD-NeighMeas is included: |

| | |
|---|---|
| 5> | if cellsForWhichToReportSFTD is configured in the corresponding |

| reportConfig: | |
|---|---|
| 6> | consider any NR neighbouring cell detected on the associated |

measObjectNR which has a physical cell identity that is included
in the cellsForWhichToReportSFTD to be applicable;

| | |
|---|---|
| 5> | else: |

| | |
|---|---|
| 6> | consider up to 3 strongest NR neighbouring cells detected based |

on parameters in the associated measObjectNR to be applicable
when the concerned cells are not included in the
excludedCellsToAddModList defined within the VarMeasConfig
for this measId;

| | |
|---|---|
| 3> | else if the corresponding measObject concerns E-UTRA: |

| | |
|---|---|
| 4> | if the reportSFTD-Meas is set to true: |

| | |
|---|---|
| 5> | consider the E-UTRA PSCell to be applicable; |

| | |
|---|---|
| 2> | else if the corresponding reportConfig includes a reportType set to cli- |

| Periodical or cli-EventTriggered: | |
|---|---|
| 3> | consider all CLI measurement resources included in the corresponding |

measObject to be applicable;

| | |
|---|---|
| 2> | else if the corresponding reportConfig includes a reportType set to |

| rxTxPeriodical: | |
|---|---|
| 3> | consider all Rx-Tx time difference measurement resources included in the |

corresponding measObject to be applicable;

| | |
|---|---|
| 2> | if the corresponding reportConfig concerns the reporting for NR sidelink |

| communication/discovery (i.e. reportConfigNR-SL): | |
|---|---|
| 3> | consider the transmission resource pools indicated by the tx- |

PoolMeasToAddModList defined within the VarMeasConfig for this
measId to be applicable;

| | |
|---|---|
| 2> | if the reportType is set to eventTriggered and if the entry condition applicable |

| for this event, i.e. the event corresponding with the eventId of the | |
|---|---|
| corresponding reportConfig within VarMeasConfig, is fulfilled for one or | |
| more applicable cells for all measurements after layer 3 filtering taken during | |
| timeToTrigger defined for this event within the VarMeasConfig, while the | |
| VarMeasReportList does not include a measurement reporting entry for this | |
| measId (a first cell triggers the event): | |
| 3> | include a measurement reporting entry within the VarMeasReportList for |
| | this measId; |
| 3> | set the numberOfReportsSent defined within the VarMeasReportList for |
| | this measId to 0; |
| 3> | include the concerned cell(s) in the cellsTriggeredList defined within the |

VarMeasReportList for this measId;

| | |
|---|---|
| 3> | if useT312 is set to true in reportConfig for this event: |

| | |
|---|---|
| 4> | if T310 for the corresponding SpCell is running; and |
| 4> | if T312 is not running for corresponding SpCell: |

| | |
|---|---|
| 5> | start timer T312 for the corresponding SpCell with the value of T312 |

configured in the corresponding measObjectNR;

| | |
|---|---|
| 3> | initiate the measurement reporting procedure, as specified in 5.5.5; |

| | |
|---|---|
| 2> | else if the reportType is set to eventTriggered and if the entry condition |

| applicable for this event, i.e. the event corresponding with the eventId of the | |
|---|---|
| corresponding reportConfig within VarMeasConfig, is fulfilled for one or | |
| more applicable cells not included in the cellsTriggeredList for all | |
| measurements after layer 3 filtering taken during timeToTrigger defined for | |
| this event within the VarMeasConfig (a subsequent cell triggers the event): | |
| 3> | set the numberOfReportsSent defined within the VarMeasReportList for |
| | this measId to 0; |
| 3> | include the concerned cell(s) in the cellsTriggeredList defined within the |
| | VarMeasReportList for this measId; |
| 3> | if useT312 is set to true in reportConfig for this event: |

| | |
|---|---|
| 4> | if T310 for the corresponding SpCell is running; and |
| 4> | if T312 is not running for corresponding SpCell: |

| | |
|---|---|
| 5> | start timer T312 for the corresponding SpCell with the value of T312 |

configured in the corresponding measObjectNR;

| | |
|---|---|
| 3> | initiate the measurement reporting procedure, as specified in 5.5.5; |

| | |
|---|---|
| 2> | if the reportType is set to eventTriggered and if the leaving condition |

| applicable for this event is fulfilled for one or more of the cells included in the | |
|---|---|
| cellsTriggeredList defined within the VarMeasReportList for this measId for | |
| all measurements after layer 3 filtering taken during timeToTrigger defined | |
| within the VarMeasConfig for this event: | |
| 3> | remove the concerned cell(s) in the cellsTriggeredList defined within the |
| | VarMeasReportList for this measId; |
| 3> | if reportOnLeave is set to true for the corresponding reporting |

| configuration: | |
|---|---|
| 4> | initiate the measurement reporting procedure, as specified in 5.5.5; |

| | |
|---|---|
| 3> | if the cellsTriggeredList defined within the VarMeasReportList for this |

| measId is empty: | |
|---|---|
| 4> | remove the measurement reporting entry within the VarMeasReportList |
| | for this measId; |
| 4> | stop the periodical reporting timer for this measId, if running; |

| | |
|---|---|
| 2> | if the reportType is set to eventTriggered and if the entry condition applicable |

| for this event, i.e. the event corresponding with the eventId of the | |
|---|---|
| corresponding reportConfig within VarMeasConfig, is fulfilled for one or | |
| more applicable L2 U2N Relay UEs for all measurements after layer 3 | |
| filtering taken during timeToTrigger defined for this event within the | |
| VarMeasConfig, while the VarMeasReportList does not include a | |
| measurement reporting entry for this measId (a first L2 U2N Relay UE | |
| triggers the event): | |
| 3> | include a measurement reporting entry within the VarMeasReportList for |
| | this measId; |
| 3> | set the numberOfReportsSent defined within the VarMeasReportList for |
| | this measId to 0; |
| 3> | include the concerned L2 U2N Relay UE(s) in the relaysTriggeredList |
| | defined within the VarMeasReportList for this measId; |
| 3> | initiate the measurement reporting procedure, as specified in 5.5.5; |

| | |
|---|---|
| 2> | else if the reportType is set to eventTriggered and if the entry condition |

| applicable for this event, i.e. the event corresponding with the eventId of the | |
|---|---|
| corresponding reportConfig within VarMeasConfig, is fulfilled for one or | |
| more applicable L2 U2N Relay UEs not included in the relaysTriggeredList | |
| for all measurements after layer 3 filtering taken during timeToTrigger defined | |
| for this event within the VarMeasConfig (a subsequent L2 U2N Relay UE | |
| triggers the event): | |
| 3> | set the numberOfReportsSent defined within the VarMeasReportList for |
| | this measId to 0; |
| 3> | include the concerned L2 U2N Relay UE(s) in the relaysTriggeredList |
| | defined within the VarMeasReportList for this measId, |
| 3> | initiate the measurement reporting procedure, as specified in 5.5.5; |

| | |
|---|---|
| 2> | else if the reportType is set to eventTriggered and if the leaving condition |

| applicable for this event is fulfilled for one or more of the L2 U2N Relay UEs | |
|---|---|
| included in the relaysTriggeredList defined within the VarMeasReportList for | |
| this measId for all measurements after layer 3 filtering taken during | |
| timeToTrigger defined within the VarMeasConfig for this event: | |
| 3> | remove the concerned L2 U2N Relay UE(s) in the relaysTriggeredList |
| | defined within the VarMeasReportList for this measId; |
| 3> | if reportOnLeave is set to true for the corresponding reporting |

| configuration: | |
|---|---|
| 4> | initiate the measurement reporting procedure, as specified in 5.5.5; |

| | |
|---|---|
| 3> | if the relaysTriggeredList defined within the VarMeasReportList for this |

| measId is empty: | |
|---|---|
| 4> | remove the measurement reporting entry within the VarMeasReportList |
| | for this measId; |
| 4> | stop the periodical reporting timer for this measId, if running; |

| | |
|---|---|
| 2> | else if the reportType is set to eventTriggered and if the entry condition |

| applicable for this event, i.e. the event corresponding with the eventId of the | |
|---|---|
| corresponding reportConfig within VarMeasConfig, is fulfilled for one or | |
| more applicable transmission resource pools for all measurements taken | |
| during timeToTrigger defined for this event within the VarMeasConfig, while | |
| the VarMeasReportList does not include an measurement reporting entry for | |
| this measId (a first transmission resource pool triggers the event): | |
| 3> | include a measurement reporting entry within the VarMeasReportList for |
| | this measId; |
| 3> | set the numberOfReportsSent defined within the VarMeasReportList for |
| | this measId to 0; |
| 3> | include the concerned transmission resource pool(s) in the |
| | poolsTriggeredList defined within the VarMeasReportList for this measId; |
| 3> | initiate the measurement reporting procedure, as specified in 5.5.5; |

| | |
|---|---|
| 2> | else if the reportType is set to eventTriggered and if the entry condition |

| applicable for this event, i.e. the event corresponding with the eventId of the | |
|---|---|
| corresponding reportConfig within VarMeasConfig, is fulfilled for one or | |
| more applicable transmission resource pools not included in the | |
| poolsTriggeredList for all measurements taken during timeToTrigger defined | |
| for this event within the VarMeasConfig (a subsequent transmission resource | |
| pool triggers the event): | |
| 3> | set the numberOfReportsSent defined within the VarMeasReportList for |
| | this measId to 0; |
| 3> | include the concerned transmission resource pool(s) in the |
| | poolsTriggeredList defined within the VarMeasReportList for this measId; |
| 3> | initiate the measurement reporting procedure, as specified in 5.5.5; |

| | |
|---|---|
| 2> | if the reportType is set to eventTriggered and if the leaving condition |

| applicable for this event is fulfilled for one or more applicable transmission | |
|---|---|
| resource pools included in the poolsTriggeredList defined within the | |
| VarMeasReportList for this measId for all measurements taken during | |
| timeToTrigger defined within the VarMeasConfig for this event: | |
| 3> | remove the concerned transmission resource pool(s) in the |
| | poolsTriggeredList defined within the VarMeasReportList for this measId, |
| 3> | if the poolsTriggeredList defined within the VarMeasReportList for this |

| measId is empty: | |
|---|---|
| 4> | remove the measurement reporting entry within the VarMeasReportList |
| | for this measId; |
| 4> | stop the periodical reporting timer for this measId, if running |

| | |
|---|---|
| 2> | else if the reportType is set to eventTriggered and if the eventId is set to |

| eventD1 and if the entering condition applicable for this event, i.e. the event | |
|---|---|
| corresponding with the eventId of the corresponding reportConfig within | |
| VarMeasConfig, is fulfilled during timeToTrigger defined for this event within | |
| the VarMeasConfig, while the VarMeasReportList does not include a | |
| measurement reporting entry for this measId: | |
| 3> | include a measurement reporting entry within the VarMeasReportList for |
| | this measId; |
| 3> | set the numberOfReportsSent defined within the VarMeasReportList for |
| | this measId to 0; |
| 3> | initiate the measurement reporting procedure, as specified in 5.5.5; |

| | |
|---|---|
| 2> | else if the reportType is set to eventTriggered and if the eventId is set to |

| eventD1 and if the leaving condition applicable for this event is fulfilled for | |
|---|---|
| the associated VarMeasReport within the VarMeasReportList for this measId | |
| during timeToTrigger defined within the VarMeasConfig for this event: | |
| 3> | if reportOnLeave is set to true for the corresponding reporting |

| configuration: | |
|---|---|
| 4> | initiate the measurement reporting procedure, as specified in 5.5.5; |

| 3> | remove the measurement reporting entry within the VarMeasReportList for |
|---|---|
| | this measId; |
| 3> | stop the periodical reporting timer for this measId, if running; |

| | |
|---|---|
| NOTE 1: | Void. |

| | |
|---|---|
| 2> | if reportType is set to periodical and if a (first) measurement result is available: |

| 3> | include a measurement reporting entry within the VarMeasReportList for |
|---|---|
| | this measId; |
| 3> | set the numberOfReportsSent defined within the VarMeasReportList for |
| | this measId to 0; |
| 3> | if the corresponding reportConfig includes measRSSI-ReportConfig: |

| | |
|---|---|
| 4> | initiate the measurement reporting procedure as specified in 5.5.5 |

immediately when RSSI sample values are reported by the physical
layer after the first L1 measurement duration;

| | |
|---|---|
| 3> | else if the corresponding reportConfig includes the ul-DelayValueConfig: |

| | |
|---|---|
| 4> | initiate the measurement reporting procedure, as specified in 5.5.5, |

immediately after a first measurement result is provided from lower
layers of the associated DRB identity;

| | |
|---|---|
| 3> | else if the corresponding reportConfig includes the ul-ExcessDelayConfig: |

| | |
|---|---|
| 4> | initiate the measurement reporting procedure, as specified in 5.5.5, |

immediately after a first measurement result is provided from lower
layers of the associated DRB identity(ies) according to the configured
threshold per DRB identity(ies);

| | |
|---|---|
| 3> | else if the reportAmount exceeds 1: |

| | |
|---|---|
| 4> | initiate the measurement reporting procedure, as specified in 5.5.5, |

immediately after the quantity to be reported becomes available for the
NR SpCell or for the serving L2 U2N Relay UE (if the UE is a L2 U2N
Remote UE);

| | |
|---|---|
| 3> | else (i.e. the reportAmount is equal to 1): |

| | |
|---|---|
| 4> | initiate the measurement reporting procedure, as specified in 5.5.5, |

immediately after the quantity to be reported becomes available for the
NR SpCell and for the strongest cell among the applicable cells, or for
the NR SpCell and for the strongest L2 U2N Relay UEs among the
applicable L2 U2N Relay UEs; or initiate the measurement reporting
procedure, as specified in 5.5.5, immediately after the quantity to be
reported becomes available for the serving L2 U2N Relay UE and for
the strongest cell among the applicable cells (if the UE is a L2 U2N
Remote UE);

| | |
|---|---|
| 2> | if, in case the corresponding reportConfig concerns the reporting for NR |

| sidelink communication/discovery, reportType is set to periodical and if a | |
|---|---|
| (first) measurement result is available: | |
| 3> | include a measurement reporting entry within the VarMeasReportList for |
| | this measId; |
| 3> | set the numberOfReportsSent defined within the VarMeasReportList for |
| | this measId to 0; |
| 3> | initiate the measurement reporting procedure, as specified in 5.5.5, |

immediately after the quantity to be reported becomes available for the NR
SpCell and CBR measurement results become available;

| | |
|---|---|
| 2> | if the reportType is set to cli-EventTriggered and if the entry condition |

| applicable for this event, i.e. the event corresponding with the eventId of the | |
|---|---|
| corresponding reportConfig within VarMeasConfig, is fulfilled for one or | |
| more applicable CLI measurement resources for all measurements after layer | |
| 3 filtering taken during timeToTrigger defined for this event within the | |
| VarMeasConfig, while the VarMeasReportList does not include a | |
| measurement reporting entry for this measId (a first CLI measurement | |
| resource triggers the event): | |
| 3> | include a measurement reporting entry within the VarMeasReportList for |
| | this measId; |
| 3> | set the numberOfReportsSent defined within the VarMeasReportList for |
| | this measId to 0; |
| 3> | include the concerned CLI measurement resource(s) in the cli- |
| | TriggeredList defined within the VarMeasReportList for this measId, |
| 3> | initiate the measurement reporting procedure, as specified in 5.5.5; |

| | |
|---|---|
| 2> | else if the reportType is set to cli-EventTriggered and if the entry condition |

| applicable for this event, i.e. the event corresponding with the eventId of the | |
|---|---|
| corresponding reportConfig within VarMeasConfig, is fulfilled for one or | |
| more CLI measurement resources not included in the cli-TriggeredList for all | |
| measurements after layer 3 filtering taken during timeToTrigger defined for | |
| this event within the VarMeasConfig (a subsequent CLI measurement resource | |
| triggers the event): | |
| 3> | set the numberOfReportsSent defined within the VarMeasReportList for |
| | this measId to 0; |
| 3> | include the concerned CLI measurement resource(s) in the cli- |
| | TriggeredList defined within the VarMeasReportList for this measId; |
| 3> | initiate the measurement reporting procedure, as specified in 5.5.5; |

| | |
|---|---|
| 2> | if the reportType is set to cli-EventTriggered and if the leaving condition |

| applicable for this event is fulfilled for one or more of the CLI measurement | |
|---|---|
| resources included in the cli-TriggeredList defined within the | |
| VarMeasReportList for this measId for all measurements after layer 3 filtering | |
| taken during timeToTrigger defined within the VarMeasConfig for this event: | |
| 3> | remove the concerned CLI measurement resource(s) in the cli- |
| | TriggeredList defined within the VarMeasReportList for this measId; |
| 3> | if reportOnLeave is set to true for the corresponding reporting |

| configuration: | |
|---|---|
| 4> | initiate the measurement reporting procedure, as specified in 5.5.5; |

| | |
|---|---|
| 3> | if the cli-TriggeredList defined within the VarMeasReportList for this |

| measId is empty: | |
|---|---|
| 4> | remove the measurement reporting entry within the VarMeasReportList |
| | for this measId; |
| 4> | stop the periodical reporting timer for this measId, if running; |

| | |
|---|---|
| 2> | if reportType is set to cli-Periodical and if a (first) measurement result is |

| available: | |
|---|---|
| 3> | include a measurement reporting entry within the VarMeasReportList for |
| | this measId; |
| 3> | set the numberOfReportsSent defined within the VarMeasReportList for |
| | this measId to 0; |
| 3> | initiate the measurement reporting procedure, as specified in 5.5.5, |

immediately after the quantity to be reported becomes available for at least
one CLI measurement resource;

| | |
|---|---|
| 2> | if reportType is set to rxTxPeriodical and if a (first) measurement result is |

| available: | |
|---|---|
| 3> | include a measurement reporting entry within the VarMeasReportList for |
| | this measId; |
| 3> | set the numberOfReportsSent defined within the VarMeasReportList for |
| | this measId to 0; |
| 3> | initiate the measurement reporting procedure, as specified in 5.5.5; |

| | |
|---|---|
| 2> | upon expiry of the periodical reporting timer for this measId: |

| | |
|---|---|
| 3> | initiate the measurement reporting procedure, as specified in 5.5.5. |

| | |
|---|---|
| 2> | if the corresponding reportConfig includes a reportType is set to reportSFTD: |

| | |
|---|---|
| 3> | if the corresponding measObject concerns NR: |

| | |
|---|---|
| 4> | if the drx-SFTD-NeighMeas is included: |

| | |
|---|---|
| 5> | if the quantity to be reported becomes available for each requested |

| pair of PCell and NR cell: | |
|---|---|
| 6> | stop timer T322; |
| 6> | initiate the measurement reporting procedure, as specified in |

5.5.5;

| | |
|---|---|
| 4> | else |

| | |
|---|---|
| 5> | initiate the measurement reporting procedure, as specified in 5.5.5, |

immediately after the quantity to be reported becomes available for
each requested pair of PCell and NR cell or the maximal
measurement reporting delay as specified in TS 38.133 [14];

| | |
|---|---|
| 3> | else if the corresponding measObject concerns E-UTRA: |

| | |
|---|---|
| 4> | initiate the measurement reporting procedure, as specified in 5.5.5, |

immediately after the quantity to be reported becomes available for the
pair of PCell and E-UTRA PSCell or the maximal measurement
reporting delay as specified in TS 38.133 [14];

| | |
|---|---|
| 2> | if reportType is set to reportCGI: |

| 3> | if the UE acquired the SIB1 or SystemInformationBlockType1 for the |
|---|---|
| | requested cell; or |
| 3> | if the UE detects that the requested NR cell is not transmitting SIB1 (see |

| TS 38.213 [13], clause 13): | |
|---|---|
| 4> | stop timer T321; |
| 4> | include a measurement reporting entry within the VarMeasReportList |
| | for this measId; |
| 4> | set the numberOfReportsSent defined within the VarMeasReportList for |
| | this measId to 0; |
| 4> | initiate the measurement reporting procedure, as specified in 5.5.5; |

| | |
|---|---|
| 2> | upon the expiry of T321 for this measId: |

| 3> | include a measurement reporting entry within the VarMeasReportList for |
|---|---|
| | this measId; |
| 3> | set the numberOfReportsSent defined within the VarMeasReportList for |
| | this measId to 0; |
| 3> | initiate the measurement reporting procedure, as specified in 5.5.5. |

| | |
|---|---|
| 2> | upon the expiry of T322 for this measId: |

| | |
|---|---|
| 3> | initiate the measurement reporting procedure, as specified in 5.5.5. |

Hereinafter, each Table will describe events related to determining whether measurement reporting is triggered.

Table 8 below relates to Event A1.

TABLE 8

| | |
|---|---|
| 5.5.4.2 | Event A1 (Serving becomes better than threshold) |

The UE shall:

| | |
|---|---|
| 1> | consider the entering condition for this event to be satisfied when condition A1-1, as |
| | specified below, is fulfilled; |
| 1> | consider the leaving condition for this event to be satisfied when condition A1-2, as |
| | specified below, is fulfilled; |
| 1> | for this measurement, consider the NR serving cell corresponding to the associated |
| | measObjectNR associated with this event. |

```
Inequality A1-1 (Entering condition)
Ms − Hys > Thresh
Inequality A1-2 (Leaving condition)
Ms + Hys < Thresh
The variables in the formula are defined as follows:
  Ms is the measurement result of the serving cell, not taking into account any offsets.
  Hys is the hysteresis parameter for this event (i.e. hysteresis as defined within reportConfigNR
    for this event).
  Thresh is the threshold parameter for this event (i.e. a1-Threshold as defined within
    reportConfigNR for this event).
  Ms is expressed in dBm in case of RSRP, or in dB in case of RSRQ and RS-SINR.
  Hys is expressed in dB.
  Thresh is expressed in the same unit as Ms.
```

Table 9 below relates to Event A2.

TABLE 9

| | |
|---|---|
| 5.5.4.3 | Event A2 (Serving becomes worse than threshold) |

The UE shall:

| | |
|---|---|
| 1> | consider the entering condition for this event to be satisfied when condition A2-1, as |
| | specified below, is fulfilled; |
| 1> | consider the leaving condition for this event to be satisfied when condition A2-2, as specified |
| | below, is fulfilled; |
| 1> | for this measurement, consider the serving cell indicated by the measObjectNR associated |
| | to this event. |

```
Inequality A2-1 (Entering condition)
Ms + Hys < Thresh
Inequality A2-2 (Leaving condition)
Ms − Hys > Thresh
The variables in the formula are defined as follows:
  Ms is the measurement result of the serving cell, not taking into account any offsets.
  Hys is the hysteresis parameter for this event (i.e. hysteresis as defined within reportConfigNR
```

for this event).

Thresh is the threshold parameter for this event (i.e. a2-Threshold as defined within

reportConfigNR for this event).

```
  Ms is expressed in dBm in case of RSRP, or in dB in case of RSRQ and RS-SINR.
  Hys is expressed in dB.
  Thresh is expressed in the same unit as Ms.
```

Table 10 below relates to Event A3.

TABLE 10

| | |
|---|---|
| 5.5.4.4 | Event A3 (Neighbour becomes offset better than SpCell) |

The UE shall:

| | |
|---|---|
| 1> | consider the entering condition for this event to be satisfied when condition A3-1, as |
| | specified below, is fulfilled; |
| 1> | consider the leaving condition for this event to be satisfied when condition A3-2, as |
| | specified below, is fulfilled; |
| 1> | use the SpCell for Mp, Ofp and Ocp. |

```
may be different from the NR SpCell measObjectNR.
Inequality A3-1 (Entering condition)
Mn + Ofn + Ocn − Hys > Mp + Ofp + Ocp + Off
Inequality A3-2 (Leaving condition)
Mn + Ofn + Ocn + Hys < Mp + Ofp + Ocp + Off
The variables in the formula are defined as follows:
    Mn is the measurement result of the neighbouring cell, not taking into account any offsets.
    Ofn is the measurement object specific offset of the reference signal of the neighbour cell (i.e.
```

offsetMO as defined within measObjectNR corresponding to the neighbour cell).

Ocn is the cell specific offset of the neighbour cell (i.e. cellIndividualOffset as defined within

```
    measObjectNR corresponding to the frequency of the neighbour cell), and set to zero
    if not configured for the neighbour cell.
```

```
    Mp is the measurement result of the SpCell, not taking into account any offsets.
    Ofp is the measurement object specific offset of the SpCell (i.e. offsetMO as defined within
```

measObjectNR corresponding to the SpCell).

Ocp is the cell specific offset of the SpCell (i.e. cellIndividualOffset as defined within

```
    measObjectNR corresponding to the SpCell), and is set to zero if not configured for
    the SpCell.
```

Hys is the hysteresis parameter for this event (i.e. hysteresis as defined within reportConfigNR

for this event).

Off is the offset parameter for this event (i.e. a3-Offset as defined within reportConfigNR for

this event).

```
    Mn, Mp are expressed in dBm in case of RSRP, or in dB in case of RSRQ and RS-SINR.
    Ofn, Ocn, Ofp, Ocp, Hys, Off are expressed in dB.
NOTE 2: The definition of Event A3 also applies to CondEvent A3.
```

Table 11 below relates to Event A4.

TABLE 11

| | |
|---|---|
| 5.5.4.5 | Event A4 (Neighbour becomes better than threshold) |

The UE shall:

| | |
|---|---|
| 1> | consider the entering condition for this event to be satisfied when |
| | condition A4-1, as specified below, is fulfilled; |
| 1> | consider the leaving condition for this event to be satisfied when |
| | condition A4-2, as specified below, is fulfilled. |

Inequality A4-1 (Entering condition)
Mn + Ofn + Ocn − Hys > Thresh
Inequality A4-2 (Leaving condition)
Mn + Ofn + Ocn + Hys < Thresh
The variables in the formula are defined as follows:
Mn is the measurement result of the neighbouring cell, not taking into account any

offsets.

Ofn is the measurement object specific offset of the neighbour cell (i.e. offsetMO

as defined within measObjectNR corresponding to the neighbour cell).

Ocn is the measurement object specific offset of the neighbour cell (i.e.

cellIndividualOffset as defined within measObjectNR corresponding to
the neighbour cell), and set to zero if not configured for the neighbour
cell.

Hys is the hysteresis parameter for this event (i.e. hysteresis as defined within

reportConfigNR for this event).

Thresh is the threshold parameter for this event (i.e. a4-Threshold as defined

within reportConfigNR for this event).

Mn is expressed in dBm in case of RSRP, or in dB in case of RSRQ and RS-SINR.
Ofn, Ocn, Hys are expressed in dB.
Thresh is expressed in the same unit as Mn.
NOTE: The definition of Event A4 also applies to CondEvent A4.

Table 12 below relates to Event A5.

TABLE 12

| | |
|---|---|
| 5.5.4.6 | Event A5 (SpCell becomes worse than threshold1 and neighbour becomes better than |
| | threshold2) |

The UE shall:

| | |
|---|---|
| 1> | consider the entering condition for this event to be satisfied when both condition |
| | A5-1 and condition A5-2, as specified below, are fulfilled; |
| 1> | consider the leaving condition for this event to be satisfied when condition A5-3 or |
| | condition A5-4, i.e. at least one of the two, as specified below, is fulfilled; |
| 1> | use the SpCell for Mp. |
| NOTE 1: | The parameters of the reference signal(s) of the cell(s) that triggers the event are |
| | indicated in the measObjectNR associated to the event which may be different from the |
| | measObjectNR of the NR SpCell. |

Inequality A5-1 (Entering condition 1)
Mp + Hys < Thresh1
Inequality A5-2 (Entering condition 2)
Mn + Ofn + Ocn − Hys > Thresh2
Inequality A5-3 (Leaving condition 1)
Mp − Hys > Thresh1
Inequality A5-4 (Leaving condition 2)
Mn + Ofn + Ocn + Hys < Thresh2
The variables in the formula are defined as follows:
Mp is the measurement result of the NR SpCell, not taking into account any offsets.
Mn is the measurement result of the neighbouring cell, not taking into account any offsets.
Ofn is the measurement object specific offset of the neighbour cell (i.e. offsetMO as defined within

measObjectNR corresponding to the neighbour cell).

Ocn is the cell specific offset of the neighbour cell (i.e. cellIndividualOffset as defined within

measObjectNR corresponding to the neighbour cell), and set to zero if not configured for
the neighbour cell.

Hys is the hysteresis parameter for this event (i.e. hysteresis as defined within reportConfigNR for

this event).

Thresh1 is the threshold parameter for this event (i.e. a5-Threshold1 as defined within

reportConfigNR for this event).

Thresh2 is the threshold parameter for this event (i.e. a5-Threshold2 as defined within

reportConfigNR for this event).

Mn, Mp are expressed in dBm in case of RSRP, or in dB in case of RSRQ and RS-SINR.
Ofn, Ocn, Hys are expressed in dB.
Thresh1is expressed in the same unit as Mp.
Thresh2 is expressed in the same unit as Mn.

| | |
|---|---|
| NOTE 2: | The definition of Event A5 also applies to CondEvent A5. |

Table 13 below relates to Event A6.

```
TABLE 13
5.5.4.7 Event A6 (Neighbour becomes offset better than SCell)
The UE shall:
1>consider the entering condition for this event to be satisfied when condition A6-
  1, as specified below, is fulfilled;
1>consider the leaving condition for this event to be satisfied when condition A6-
  2, as specified below, is fulfilled;
1>for this measurement, consider the (secondary) cell corresponding to the
  measObjectNR associated to this event to be the serving cell.
NOTE: The reference signal(s) of the neighbour(s) and the reference signal(s)
  of the SCell are both indicated in the associated measObjectNR.
Inequality A6-1 (Entering condition)
Mn + Ocn − Hys > Ms + Ocs + Off
Inequality A6-2 (Leaving condition)
Mn + Ocn + Hys < Ms + Ocs + Off
The variables in the formula are defined as follows:
Mn is the measurement result of the neighbouring cell, not taking into account any
  offsets.
Ocn is the cell specific offset of the neighbour cell (i.e. cellIndividualOffset as
  defined within the associated measObjectNR), and set to zero if not configured
  for the neighbour cell.
Ms is the measurement result of the serving cell, not taking into account any
  offsets.
Ocs is the cell specific offset of the serving cell (i.e. cellIndividualOffset as defined
  within the associated measObjectNR), and is set to zero if not configured for the
  serving cell.
Hys is the hysteresis parameter for this event (i.e. hysteresis as defined within
  reportConfigNR for this event).
Off is the offset parameter for this event (i.e. a6-Offset as defined within
  reportConfigNR for this event).
Mn, Ms are expressed in dBm in case of RSRP, or in dB in case of RSRQ and RS-
  SINR.
Ocn, Ocs, Hys, Off are expressed in dB.
```

Table 14 below relates to Event B1.

TABLE 14
5.5.4.8 Event B1 (Inter RAT neighbour becomes better than threshold)
The UE shall:

| | |
|---|---|
| 1> | consider the entering condition for this event to be satisfied when condition B1-1, as specified |
| | below, is fulfilled; |
| 1> | consider the leaving condition for this event to be satisfied when condition B1-2, as specified |
| | below, is fulfilled. |

Inequality B1-1 (Entering condition)
Mn + Ofn + Ocn − Hys > Thresh
Inequality B1-2 (Leaving condition)
Mn + Ofn + Ocn + Hys < Thresh
The variables in the formula are defined as follows:
Mn is the measurement result of the inter-RAT neighbour cell, not taking into account any offsets.
Ofn is the measurement object specific offset of the frequency of the inter-RAT neighbour cell (i.e.

eutra-Q-OffsetRange as defined within the measObjectEUTRA corresponding to the frequency of
the neighbour inter-RAT cell, utra-FDD-Q-OffsetRange as defined within the measObjectUTRA-
FDD corresponding to the frequency of the neighbour inter-RAT cell).

Ocn is the cell specific offset of the inter-RAT neighbour cell (i.e. cellIndividualOffset as defined

within the measObjectEUTRA corresponding to the neighbour inter-RAT cell), and set to zero if
not configured for the neighbour cell.

Hys is the hysteresis parameter for this event (i.e. hysteresis as defined within reportConfigInterRAT

for this event).

Thresh is the threshold parameter for this event (i.e. b1-ThresholdEUTRA as defined within

reportConfigInterRAT for this event, b1-ThresholdUTRA-FDD as defined for UTRA-FDD within
reportConfigInterRAT for this event).

Mn is expressed in dBm or in dB, depending on the measurement quantity of the inter-RAT neighbour

cell.

Ofn, Ocn, Hys are expressed in dB.
Thresh is expressed in the same unit as Mn.

Table 15 below relates to Event B2.

TABLE 15
5.5.4.9 Event B2 (PCell becomes worse than threshold1 and inter RAT neighbour becomes

better than threshold2)

The UE shall:

| | |
|---|---|
| 1> | consider the entering condition for this event to be satisfied when both condition B2-1 and |
| | condition B2-2, as specified below, are fulfilled; |
| 1> | consider the leaving condition for this event to be satisfied when condition B2-3 or condition B2- |
| | 4, i.e. at least one of the two, as specified below, is fulfilled; |

Inequality B2-1 (Entering condition 1)
Mp + Hys < Thresh1
Inequality B2-2 (Entering condition 2)
Mn + Ofn + Ocn − Hys > Thresh2
Inequality B2-3 (Leaving condition 1)
Mp − Hys > Thresh1
Inequality B2-4 (Leaving condition 2)
Mn + Ofn + Ocn + Hys < Thresh2
The variables in the formula are defined as follows:
Mp is the measurement result of the PCell, not taking into account any offsets.
Mn is the measurement result of the inter-RAT neighbour cell, not taking into account any offsets.
Ofn is the measurement object specific offset of the frequency of the inter-RAT neighbour cell (i.e.

eutra-Q-OffsetRange as defined within the measObjectEUTRA corresponding to the frequency of
the inter-RAT neighbour cell, utra-FDD-Q-OffsetRange as defined within the measObjectUTRA-
FDD corresponding to the frequency of the neighbour inter-RAT cell).

Ocn is the cell specific offset of the inter-RAT neighbour cell (i.e. cellIndividualOffset as defined

within the measObjectEUTRA corresponding to the neighbour inter-RAT cell), and set to zero if
not configured for the neighbour cell.

Hys is the hysteresis parameter for this event (i.e. hysteresis as defined within reportConfigInterRAT

for this event).

Thresh1 is the threshold parameter for this event (i.e. b2-Threshold1 as defined within

reportConfigInterRAT for this event).

Thresh2 is the threshold parameter for this event (i.e. b2-Threshold2EUTRA as defined within

reportConfigInterRAT for this event, b2-Threshold2UTRA-FDD as defined for UTRA-FDD
within reportConfigInterRAT for this event).

Mp is expressed in dBm in case of RSRP, or in dB in case of RSRQ and SINR.
Mn is expressed in dBm or dB, depending on the measurement quantity of the inter-RAT neighbour

cell.

Ofn, Ocn, Hys are expressed in dB.
Thresh1 is expressed in the same unit as Mp.
Thresh2 is expressed in the same unit as Mn.

Table 16 below relates to Event I1.

TABLE 16
5.5.4.10 Event I1 (Interference becomes higher than threshold)
The UE shall:

| | |
|---|---|
| 1> | consider the entering condition for this event to be satisfied when condition I1-1, as specified |
| | below, is fulfilled; |
| 1> | consider the leaving condition for this event to be satisfied when condition I1-2, as specified |
| | below, is fulfilled. |

Inequality I1-1 (Entering condition)
Mi − Hys > Thresh
Inequality I1-2 (Leaving condition)
Mi+ Hys < Thresh
The variables in the formula are defined as follows:
Mi is the measurement result of the interference, not taking into account any offsets.
Hys is the hysteresis parameter for this event (i.e. hysteresis as defined within reportConfigNR for

this event).

Thresh is the threshold parameter for this event (i.e. i1-Threshold as defined within reportConfigNR

for this event).

Mi, Thresh are expressed in dBm.
Hys is expressed in dB.

Table 17 below relates to Event C1.

```
TABLE 17
5.5.4.11 Event C1 (The NR sidelink channel busy ratio is above a threshold)
The UE shall:
1> consider the entering condition for this event to be satisfied when condition C1-1, as specified
  below, is fulfilled;
1> consider the leaving condition for this event to be satisfied when condition C1-2, as specified
  below, is fulfilled;
Inequality C1-1 (Entering condition)
            Ms − Hys > Thresh
Inequality C1-2 (Leaving condition)
            Ms + Hys < Thresh
The variables in the formula are defined as follows:
Ms is the measurement result of channel busy ratio of the transmission resource pool, not taking into
  account any offsets.
Hys is the hysteresis parameter for this event (i.e. hysteresis as defined within reportConfigNR-SL
  for this event).
Thresh is the threshold parameter for this event (i.e. c1-Threshold as defined within reportConfigNR-
  SL for this event).
Ms is expressed in decimal from 0 to 1 in steps of 0.01.
Hys is expressed is in the same unit as Ms.
Thresh is expressed in the same unit as Ms.
```

Table 18 below relates to Event C2.

```
TABLE 18
5.5.4.12 Event C2 (The NR sidelink channel busy ratio is below a threshold)
The UE shall:
1> consider the entering condition for this event to be satisfied when condition C2-1, as specified
  below, is fulfilled;
1> consider the leaving condition for this event to be satisfied when condition C2-2, as specified
  below, is fulfilled;
Inequality C2-1 (Entering condition)
            Ms + Hys < Thresh
Inequality C2-2 (Leaving condition)
            Ms − Hys > Thresh
The variables in the formula are defined as follows:
Ms is the measurement result of channel busy ratio of the transmission resource pool, not taking into
  account any offsets.
Hys is the hysteresis parameter for this event (i.e. hysteresis as defined within reportConfigNR-SL
  for this event).
Thresh is the threshold parameter for this event (i.e. c2-Threshold as defined within reportConfigNR-
  SL for this event).
Ms is expressed in decimal from 0 to 1 in steps of 0.01.
Hys is expressed is in the same unit as Ms.
Thresh is expressed in the same unit as Ms.
```

Table 19 below relates to Event D1.

TABLE 19

| | |
|---|---|
| 5.5.4.15 | Event D1 (Distance between UE and referenceLocation1 is above threshold1 and distance |
| | between UE and referenceLocation2 is below threshold2) |

The UE shall:

| | |
|---|---|
| 1> | consider the entering condition for this event to be satisfied when both condition D1-1 and |
| | condition D1-2, as specified below, are fulfilled; |
| 1> | consider the leaving condition for this event to be satisfied when condition D1-3 or |
| | condition D1-4, i.e. at least one of the two, as specified below, are fulfilled; |

Inequality D1-1 (Entering condition 1)

Ml1 − Hys > Thresh1

Inequality D1-2 (Entering condition 2)
Ml2 + Hys < Thresh2
Inequality D1-3 (Leaving condition 1)

Ml1 − Hys < Thresh1

Inequality D1-4 (Leaving condition 2)

Ml2 - Hys > Thresh2

The variables in the formula are defined as follows:
Ml1 is the UE location, represented by the distance between UE and a reference location parameter

for this event (i.e. referenceLocation1 as defined within reportConfigNR for this event),
not taking into account any offsets.

Ml2 is the UE location, represented by the distance between UE and a reference location parameter

for this event (i.e. referenceLocation2 as defined within reportConfigNR for this event),
not taking into account any offsets.

Hys is the hysteresis parameter for this event (i.e. hysteresis as defined within reportConfigNR for

this event).

Thresh1 is the threshold for this event defined as a distance, configured with parameter

distanceThreshFromReference1, from a reference location configured with parameter
referenceLocation1 within reportConfigNR for this event.

Thresh2 is the threshold for this event defined as a distance, configured with parameter

distanceThreshFromReference2, from a reference location configured with parameter
referenceLocation2 within reportConfigNR for this event.

Ml1 is expressed in meters.
Ml2 is expressed in the same unit as Ml1.
Hys is expressed in the same unit as Ml1.
Thresh1 is expressed in the same unit as Ml1.
Thresh2 is expressed in the same unit as Ml1.

| | |
|---|---|
| NOTE: | The definition of Event D1 also applies to CondEvent D1. |

Table 20 below relates to CondEvent T1.

TABLE 20
5.5.4.16 CondEvent T1 (Time measured at UE is within a duration from threshold)
The UE shall:
1> consider the entering condition for this event to be satisfied when condition T1-1, as specified
below, is fulfilled;
1> consider the leaving condition for this event to be satisfied when condition T1-2, as specified
below, is fulfilled;
Inequality T1-1 (Entering condition)
Mt > Thresh1
Inequality T1-2 (Leaving condition)
Mt > Thresh1 + Duration
The variables in the formula are defined as follows:
Mt is the time measured at UE.
Thresh1 is the threshold parameter for this event (i.e. t1-Threshold as defined within reportConfigNR
for this event).
Duration is the duration parameter for this event (i.e. duration as defined within reportConfigNR for
this event).
Mt is expressed in ms.
Thresh1 is expressed in the same unit as Mt.
Duration is expressed in the same unit as Mt.

Table 21 below relates to Event X1.

TABLE 21
5.5.4.17 Event X1 (Serving L2 U2N Relay UE becomes worse than threshold1 and NR Cell becomes
better than threshold2)
The UE shall:
1> consider the entering condition for this event to be satisfied when both condition X1-1 and
condition X1-2, as specified below, are fulfilled;
1> consider the leaving condition for this event to be satisfied when condition X1-3 or condition
X1-4, i.e. at least one of the two, as specified below, is fulfilled;
Inequality X1-1 (Entering condition 1)
Mr + Hys < Thresh1
Inequality X1-2 (Entering condition 2)
Mn + Ofn + Ocn − Hys > Thresh2
Inequality X1-3 (Leaving condition 1)
Mr − Hys > Thresh1
Inequality X1-4 (Leaving condition 2)
Mn + Ofn + Ocn + Hys < Thresh2
The variables in the formula are defined as follows:
Mr is the measurement result of the serving L2 U2N Relay UE, not taking into account any offsets.
Mn is the measurement result of the NR cell, not taking into account any offsets.
Ofn is the measurement object specific offset of the reference signal of the NR cell (i.e. offsetMO as
defined within measObjectNR corresponding to the NR cell).
Ocn is the cell specific offset of the NR cell (i.e. cellIndividualOffset as defined within measObjectNR
corresponding to the frequency of the NR cell), and set to zero if not configured for the cell.
Hys is the hysteresis parameter for this event.
Thresh1 is the threshold parameter for this event (i.e. x1-Threshold1-Relay as defined within
reportConfigNR for this event).
Thresh 2 is the threshold parameter for this event (i.e. x1-Threshold2 as defined within reportConfigNR
for this event).
Mr is expressed in dBm.
Mn is expressed in dBm in case of RSRP, or in dB in case of RSRQ and RS-SINR.
Ofn, Ocn, Hys are expressed in dB.
Thresh1 is expressed in the same unit as Mr.
Thresh2 is expressed in the same unit as Mn.

Table 22 below relates to Event X2.

TABLE 22
5.5.4.18 Event X2 (Serving L2 U2N Relay UE becomes worse than threshold)
The UE shall:

| | |
|---|---|
| 1> | consider the entering condition for this event to be satisfied when condition X2-1, as |
| | specified below, is fulfilled; |
| 1> | consider the leaving condition for this event to be satisfied when condition X2-2, as specified |
| | below, is fulfilled; |

Inequality X2-1 (Entering condition)
Mr + Hys < Thresh
Inequality X2-2 (Leaving condition)
Mr − Hys > Thresh
The variables in the formula are defined as follows:
Mr is the measurement result of the serving L2 U2N Relay UE, not taking into account any offsets.
Hys is the hysteresis parameter for this event.
Thresh is the threshold parameter for this event (i.e. x2-Threshold-Relay as defined within
reportConfigNR for this event).
Mr is expressed in dBm.
Hys are expressed in dB.
Thresh is expressed in the same unit as Mr.

Table 23 below relates to Event Y1.

```
TABLE 23
5.5.4.19 Event Y1 (PCell becomes worse than threshold1 and candidate L2 U2N Relay UE
  becomes better than threshold2)
The UE shall:
1> consider the entering condition for this event to be satisfied when both condition Y1-1 and
  condition Y1-2, as specified below, are fulfilled;
1> consider the leaving condition for this event to be satisfied when condition Y1-3 or condition
  Y1-4, i.e. at least one of the two, as specified below, is fulfilled;
Inequality Y1-1 (Entering condition 1)
Mp + Hys < Thresh1
Inequality Y1-2 (Entering condition 2)
Mr− Hys > Thresh2
Inequality Y1-3 (Leaving condition 1)
Mp − Hys > Thresh1
Inequality Y1-4 (Leaving condition 2)
Mr + Hys < Thresh2
The variables in the formula are defined as follows:
Mp is the measurement result of the PCell, not taking into account any offsets.
Mr is the measurement result of the candidate L2 U2N Relay UE, not taking into account any
  offsets.
Hys is the hysteresis parameter for this event (i.e. hysteresis as defined within
  reportConfigInterRAT for this event).
Thresh1 is the threshold parameter for this event (i.e. y1-Threshold1 as defined within
  reportConfigInterRAT for this event).
Thresh2 is the threshold parameter for this event (i.e. y1-Threshold2-Relay as defined within
  reportConfigInterRAT for this event).
Mp is expressed in dBm in case of RSRP, or in dB in case of RSRQ and SINR.
Mr is expressed in dBm or dB, depending on the measurement quantity of candidate L2 U2N Relay
  UE.
Hys are expressed in dB.
Thresh1 is expressed in the same unit as Mp.
Thresh2 is expressed in the same unit as Mr.
```

Table 24 below relates to Event Y2.

TABLE 24
5.5.4.20 Event Y2 (Candidate L2 U2N Relay UE becomes better than threshold)
The UE shall:

| | |
|---|---|
| 1> | consider the entering condition for this event to be satisfied when condition Y2-1, as |
| | specified below, is fulfilled; |
| 1> | consider the leaving condition for this event to be satisfied when condition Y2-2, as specified |
| | below, is fulfilled; |

```
Inequality Y2-1 (Entering condition)
Mr− Hys > Thresh2
Inequality Y2-2 (Leaving condition)
Mr + Hys < Thresh2
The variables in the formula are defined as follows:
Mr is the measurement result of the candidate L2 U2N Relay UE, not taking into account any offsets.
Hys is the hysteresis parameter for this event (i.e. hysteresis as defined within reportConfigInterRAT
  for this event).
Thresh is the threshold parameter for this event (i.e. y2-Threshold-Relay as defined within
  reportConfigInterRAT for this event).
Mr is expressed in dBm or dB, depending on the measurement quantity of candidate L2 U2N Relay
  UE.
Hys are expressed in dB.
Thresh is expressed in the same unit as Mr.
```

Referring to FIG. 5, in step 525, the first terminal 501 may include in a measurement result message (MeasurementReport), a measurement result (measResults) for measId and a measurement reporting procedure of which has been triggered in step 520, and transmit the MeasurementReport to the base station 502. More specifically, the first terminal 501 may first measure E-UTRA carrier frequency x, identify measId (i.e., measId=1) associated with measObjectId=1 corresponding to E-UTRA carrier frequency x. If it is identified that a measurement reporting procedure has been triggered based on a measurement reporting condition (reportConfigId=1) mapped to the measId, the first terminal 501 may transmit a measurement result for the measId to the base station 502. In step 526, the second terminal 503 may include a measurement result (measResults) for measId, a measurement reporting procedure of which has been triggered in step 521, in a measurement result message (MeasurementReport) and transmit the measResults to the base station 502. Unlike the first terminal 501, since E-UTRA carrier frequency z is first measured, the measurement reporting procedure by the second terminal 503 may have been triggered based on measId (i.e., measId=3) associated with measObjectId=3 corresponding to E-UTRA carrier frequency z and a measurement reporting condition (reportConfigId=3) mapped thereto. A method of receiving beam measurement information and a cell measurement result in a measurement result by each terminal 501 or 503 may be the same as defined in Table 25 below.

```
TABLE 25
5.5.5.2 Reporting of beam measurement information
For beam measurement information to be included in a measurement report the UE shall:
1> if reportType is set to eventTriggered:
  2> consider the trigger quantity as the sorting quantity if available, otherwise RSRP as sorting
      quantity if available, otherwise RSRQ as sorting quantity if available, otherwise SINR as
      sorting quantity;
1> if reportType is set to periodical:
  2> if a single reporting quantity is set to true in reportQuantityRS-Indexes;
    3> consider the configured single quantity as the sorting quantity;
  2> else:
    3> if rsrp is set to true;
        4> consider RSRP as the sorting quantity;
    3> else:
        4> consider RSRQ as the sorting quantity;
1> set rsIndexResults to include up to maxNrofRS-IndexesToReport SS/PBCH block indexes or
    CSI-RS indexes in order of decreasing sorting quantity as follows:
  2> if the measurement information to be included is based on SS/PBCH block:
    3> include within resultsSSB-Indexes the index associated to the best beam for that
        SS/PBCH block sorting quantity and if absThreshSS-BlocksConsolidation is included in
        the VarMeasConfig for the measObject associated to the cell for which beams are to be
        reported, the remaining beams whose sorting quantity is above absThreshSS-
        BlocksConsolidation;
    3> if includeBeamMeasurements is set to true, include the SS/PBCH based measurement
        results for the quantities in reportQuantityRS-Indexes for each SS/PBCH block index;
  2> else if the beam measurement information to be included is based on CSI-RS:
    3> include within resultsCSI-RS-Indexes the index associated to the best beam for that CSI-
        RS sorting quantity and, if absThreshCSI-RS-Consolidation is included in the
        VarMeasConfig for the measObject associated to the cell for which beams are to be
        reported, the remaining beams whose sorting quantity is above absThreshCSI-RS-
        Consolidation;
    3> if includeBeamMeasurements is set to true, include the CSI-RS based measurement
        results for the quantities in reportQuantityRS-Indexes for each CSI-RS index.
5.5.5.3 Sorting of cell measurement results
The UE shall determine the sorting quantity according to parameters of the reportConfig
    associated with the measId that triggered the reporting:
1> if the reportType is set to eventTriggered:
  2> for an NR cell, consider the quantity used in the aN-Threshold (for eventA1, eventA2 and
      eventA4) or in the a5-Threshold2 (for eventA5) or in the aN-Offset (for eventA3 and
      eventA6) as the sorting quantity;
  2> for an E-UTRA cell, consider the quantity used in the bN-ThresholdEUTRA as the sorting
      quantity;
  2> for an UTRA-FDD cell, consider the quantity used in the bN-ThresholdUTRA-FDD as the
      sorting quantity;
  2> for a candidate L2 U2N Relay UE, consider the yN-Threshold2-Relay as the sorting
      quantity;
1> if the reportType is set to periodical:
  2> determine the sorting quantity according to reportQuantityCell for an NR cell, and
      according to reportQuantity for an E-UTRA cell, as below:
    3> if a single quantity is set to true:
        4> consider this quantity as the sorting quantity;
    3> else:
        4> if rsrp is set to true;
          5> consider RSRP as the sorting quantity;
        4> else:
          5> consider RSRQ as the sorting quantity;
    2> determine the sorting quantity according to reportQuantityUTRA-FDD for UTRA-FDD
        cell, as below:
    3> if a single quantity is set to true:
        4> consider this quantity as the sorting quantity;
    3> else:
        4> consider RSCP as the sorting quantity.
2> for a candidate L2 U2N Relay UE, consider the reportQuantityRelay as the sorting quantity;
```

A detailed procedure of including a measurement result (MeasResults) in a measurement reporting message by each terminal 501 or 503 may be as shown in Table 26 below.

```
TABLE 26
1> set the measId to the measurement identity that triggered the measurement reporting;
1> for each serving cell configured with servingCellMO:
  2> if the reportConfig associated with the measId that triggered the measurement reporting
    includes rsType:
    3> if the serving cell measurements based on the rsType included in the reportConfig that
      triggered the measurement report are available:
      4> set the measResultServingCell within measResultServingMOList to include RSRP,
        RSRQ and the available SINR of the serving cell, derived based on the rsType included
        in the reportConfig that triggered the measurement report;
  2> else:
    3> if SSB based serving cell measurements are available:
      4> set the measResultServingCell within measResultServingMOList to include RSRP,
        RSRQ and the available SINR of the serving cell, derived based on SSB;
    3> else if CSI-RS based serving cell measurements are available:
      4> set the measResultServingCell within measResultServingMOList to include RSRP,
        RSRQ and the available SINR of the serving cell, derived based on CSI-RS;
1> set the servCellId within measResultServingMOList to include each NR serving cell that is
  configured with servingCellMO, if any;
1> if the reportConfig associated with the measId that triggered the measurement reporting includes
  reportQuantityRS-Indexes and maxNrofRS-IndexesToReport:
  2> for each serving cell configured with servingCellMO, include beam measurement information
    according to the associated reportConfig as described in 5.5.5.2;
1> if the reportConfig associated with the measId that triggered the measurement reporting includes
  reportAddNeighMeas:
  2> for each measObjectId referenced in the measIdList which is also referenced with
    servingCellMO, other than the measObjectId corresponding with the measId that triggered the
    measurement reporting:
    3> if the measObjectNR indicated by the servingCellMO includes the RS resource
      configuration corresponding to the rsType indicated in the reportConfig:
      4> set the measResultBestNeighCell within measResultServingMOList to include the
        physCellId and the available measurement quantities based on the reportQuantityCell
        and rsType indicated in reportConfig of the non-serving cell corresponding to the
        concerned measObjectNR with the highest measured RSRP if RSRP measurement
        results are available for cells corresponding to this measObjectNR, otherwise with the
        highest measured RSRQ if RSRQ measurement results are available for cells
        corresponding to this measObjectNR, otherwise with the highest measured SINR;
      4> if the reportConfig associated with the measId that triggered the measurement
        reporting includes reportQuantityRS-Indexes and maxNrofRS-IndexesToReport:
        5> for each best non-serving cell included in the measurement report:
          6> include beam measurement information according to the associated
            reportConfig as described in 5.5.5.2;
1> if the reportConfig associated with the measId that triggered the measurement reporting is set to
  eventTriggered and eventID is set to eventA3, or eventA4, or eventA5, or eventB1, or eventB2:
  2> if the UE is in NE-DC and the measurement configuration that triggered this measurement
    report is associated with the MCG:
    3> set the measResultServFreqListEUTRA-SCG to include an entry for each E-UTRA SCG
      serving frequency with the following:
      4> include carrierFreq of the E-UTRA serving frequency;
      4> set the measResultServingCell to include the available measurement quantities that the
        UE is configured to measure by the measurement configuration associated with the
        SCG;
      4> if reportConfig associated with the measId that triggered the measurement reporting
        includes reportAddNeighMeas:
        5> set the measResultServFreqListEUTRA-SCG to include within
          measResultBestNeighCell the quantities of the best non-serving cell, based on
          RSRP, on the concerned serving frequency;
1> if reportConfig associated with the measId that triggered the measurement reporting is set to
  eventTriggered and eventID is set to eventA3, or eventA4, or eventA5:
  2> if the UE is in NR-DC and the measurement configuration that triggered this measurement
    report is associated with the MCG:
    3> set the measResultServFreqListNR-SCG to include for each NR SCG serving cell that is
      configured with servingCellMO, if any, the following:
      4> if the reportConfig associated with the measId that triggered the measurement
        reporting includes rsType:
        5> if the serving cell measurements based on the rsType included in the reportConfig
          that triggered the measurement report are available according to the measurement
          configuration associated with the SCG:
          6> set the measResultServingCell within measResultServFreqListNR-SCG to
            include RSRP, RSRQ and the available SINR of the serving cell, derived based
            on the rsType included in the reportConfig that triggered the measurement
            report;
      4> else:
        5> if SSB based serving cell measurements are available according to the
          measurement configuration associated with the SCG:
          6> set the measResultServingCell within measResultServFreqListNR-SCG to
            include RSRP, RSRQ and the available SINR of the serving cell, derived based
            on SSB;
        5> else if CSI-RS based serving cell measurements are available according to the
          measurement configuration associated with the SCG:
          6> set the measResultServingCell within measResultServFreqListNR-SCG to
            include RSRP, RSRQ and the available SINR of the serving cell, derived based
            on CSI-RS;
      4> if results for the serving cell derived based on SSB are included:
        5> include the ssbFrequency to the value indicated by ssbFrequency as included in the
          MeasObjectNR of the serving cell;
      4> if results for the serving cell derived based on CSI-RS are included:
        5> include the refFreqCSI-RS to the value indicated by refFreqCSI-RS as included in
          the MeasObjectNR of the serving cell;
      4> if the reportConfig associated with the measId that triggered the measurement
        reporting includes reportQuantityRS-Indexes and maxNrofRS-IndexesToReport:
        5> for each serving cell configured with servingCellMO, include beam measurement
          information according to the associated reportConfig as described in 5.5.5.2, where
          availability is considered according to the measurement configuration associated
          with the SCG;
      4> if reportConfig associated with the measId that triggered the measurement reporting
        includes reportAddNeighMeas:
        5> if the measObjectNR indicated by the servingCellMO includes the RS resource
          configuration corresponding to the rsType indicated in the reportConfig:
          6> set the measResultNeighCellListNR within measResultServFreqListNR-SCG to
            include one entry with the physCellId and the available measurement quantities
            based on the reportQuantityCell and rsType indicated in reportConfig of the
            non-serving cell corresponding to the concerned measObjectNR with the
            highest measured RSRP if RSRP measurement results are available for cells
            corresponding to this measObjectNR, otherwise with the highest measured
            RSRQ if RSRQ measurement results are available for cells corresponding to
            this measObjectNR, otherwise with the highest measured SINR, where
            availability is considered according to the measurement configuration
            associated with the SCG;
            7> if the reportConfig associated with the measId that triggered the
              measurement reporting includes reportQuantityRS-Indexes and
              maxNrofRS-IndexesToReport:
              8> for each best non-serving cell included in the measurement report:
                9> include beam measurement information according to the associated
                  reportConfig as described in 5.5.5.2, where availability is considered
                  according to the measurement configuration associated with the
                  SCG;
1> if the measRSSI-ReportConfig is configured within the corresponding reportConfig for this
  measId:
  2> set the rssi-Result to the linear average of sample value(s) provided by lower layers in the
    reportInterval;
  2> set the channelOccupancy to the rounded percentage of sample values which are beyond the
    channelOccupancyThreshold within all the sample values in the reportInterval;
1> if the UE is acting as L2 U2N Remote UE:
  2> set the sl-MeasResultServingRelay in accordance with the following:
    3> set the cellIdentity to include the cellAccessRelatedInfo contained in the discovery
      message received from the serving L2 U2N Relay UE;
    3> set the sl-RelayUE-Identity to include the Source L2 ID of the serving L2 U2N Relay;
    3> set the sl-MeasResult to include the SL-RSRP of the serving L2 U2N Relay UE;
NOTE 1: In case of no data transmission from L2 U2N Relay UE to L2 U2N Remote UE, it is left
      to UE implementation whether to use SL-RSRP or SD-RSRP when setting the sl-
      MeasResultServingRelay of the serving L2 U2N Relay UE.
1> if there is at least one applicable neighbouring cell or candidate L2 U2N Relay UE to report:
  2> if the reportType is set to eventTriggered or periodical:
    3> if the measurement report concerns the candidate L2 U2N Relay UE:
      4> set the sl-MeasResultsCandRelay in measResultNeighCells to include the best
        candidate L2 U2N Relay UEs up to maxReportCells in accordance with the following:
        5> if the reportType is set to eventTriggered:
          6> include the L2 U2N Relay UEs included in the relaysTriggeredList as defined
            within the VarMeasReportList for this measId;
        5> else:
          6> include the applicable L2 U2N Relay UEs for which the new measurement
            results became available since the last periodical reporting or since the
            measurement was initiated or reset;
        5> for each L2 U2N Relay UE that is included in the sl-MeasResultsCandRelay:
          6> set the cellIdentity to include the cellAccessRelatedInfo contained in the
            discovery message received from the concerned L2 U2N Relay UE;
          6> set the sl-RelayUE-Identity to include the Source L2 ID of the concerned L2
            U2N Relay UE;
          6> set the sl-MeasResult to include the SD-RSRP of the concerned L2 U2N Relay
            UE;
        5> for each included L2 U2N Relay UE, include the layer 3 filtered measured results
          in accordance with the reportConfig for this measId, ordered as follows:
          6> set the sl-MeasResult to include the quantity(ies) indicated in the
            reportQuantityRelay within the concerned reportConfigRelay in decreasing
            order of the sorting quantity, determined as specified in 5.5.5.3, i.e. the best L2
            U2N Relay UE is included first;
    3> else:
      4> set the measResultNeighCells to include the best neighbouring cells up to
        maxReportCells in accordance with the following:
        5> if the reportType is set to eventTriggered and eventId is not set to eventD1:
          6> include the cells included in the cellsTriggeredList as defined within the
            VarMeasReportList for this measId;
        5> else:
          6> include the applicable cells for which the new measurement results became
            available since the last periodical reporting or since the measurement was
            initiated or reset;
        5> for each cell that is included in the measResultNeighCells, include the physCellId;
        5> if the reportType is set to eventTriggered or periodical:
          6> for each included cell, include the layer 3 filtered measured results in
            accordance with the reportConfig for this measId, ordered as follows:
            7> if the measObject associated with this measId concerns NR:
              8> if rsType in the associated reportConfig is set to ssb:
                9> set resultsSSB-Cell within the measResult to include the SS/PBCH
                  block based quantity(ies) indicated in the reportQuantityCell within
                  the concerned reportConfig, in decreasing order of the sorting
                  quantity, determined as specified in 5.5.5.3, i.e. the best cell is
                  included first;
                9> if reportQuantityRS-Indexes and maxNrofRS-IndexesToReport are
                  configured, include beam measurement information as described in
                  5.5.5.2;
              8> else if rsType in the associated reportConfig is set to csi-rs:
                9> set resultsCSI-RS-Cell within the measResult to include the CSI-RS
                  based quantity(ies) indicated in the reportQuantityCell within the
                  concerned reportConfig, in decreasing order of the sorting quantity,
                  determined as specified in 5.5.5.3, i.e. the best cell is included first;
                9> if reportQuantityRS-Indexes and maxNrofRS-IndexesToReport are
                  configured, include beam measurement information as described in
                  5.5.5.2;
            7> if the measObject associated with this measId concerns E-UTRA:
              8> set the measResult to include the quantity(ies) indicated in the
                reportQuantity within the concerned reportConfigInterRAT in
                decreasing order of the sorting quantity, determined as specified in
                5.5.5.3, i.e. the best cell is included first;
            7> if the measObject associated with this measId concerns UTRA-FDD and if
              ReportConfigInterRAT includes the reportQuantityUTRA-FDD:
              8> set the measResult to include the quantity(ies) indicated in the
                reportQuantityUTRA-FDD within the concerned reportConfigInterRAT
                in decreasing order of the sorting quantity, determined as specified in
                5.5.5.3, i.e. the best cell is included first;
  2> else:
    3> if the cell indicated by cellForWhichToReportCGI is an NR cell:
      4> if plmn-IdentityInfoList of the cgi-Info for the concerned cell has been obtained:
        5> include the plmn-IdentityInfoList including plmn-IdentityList, trackingAreaCode
          (if available), trackingAreaList (if available), ranac (if available), cellIdentity and
          cellReservedForOperatorUse for each entry of the plmn-IdentityInfoList;
        5> include frequencyBandList if available;
        5> for each PLMN-IdentityInfo in plmn-IdentityInfoList:
          6> if the gNB-ID-Length is broadcast:
            7> include gNB-ID-Length;
      4> if nr-CGI-Reporting-NPN is supported by the UE and npn-IdentityInfoList of the cgi-
        Info for the concerned cell has been obtained:
        5> include the npn-IdentityInfoList including npn-IdentityList, trackingAreaCode,
          ranac (if available), cellIdentity and cellReservedForOperatorUse for each entry
          of the npn-IdentityInfoList,
        5> for each NPN-IdentityInfo in NPN-IdentityInfoList:
          6> if the gNB-ID-Length is broadcast:
            7> include gNB-ID-Length;
        5> include cellReservedForOtherUse if available;
      4> else if MIB indicates the SIB1 is not broadcast:
        5> include the noSIB1 including the ssb-SubcarrierOffset and pdcch-ConfigSIB1
          obtained from MIB of the concerned cell;
    3> if the cell indicated by cellForWhichToReportCGI is an E-UTRA cell:
      4> if all mandatory fields of the cgi-Info-EPC for the concerned cell have been obtained:
        5> include in the cgi-Info-EPC the fields broadcasted in E-UTRA
          SystemInformationBlockType1 associated to EPC;
      4> if the UE is E-UTRA/5GC capable and all mandatory fields of the cgi-Info-5GC for
        the concerned cell have been obtained:
        5> include in the cgi-Info-5GC the fields broadcasted in E-UTRA
          SystemInformationBlockType1 associated to 5GC;
      4> if the mandatory present fields of the cgi-Info for the cell indicated by the
        cellForWhichToReportCGI in the associated measObject have been obtained:
        5> include the freqBandIndicator;
        5> if the cell broadcasts the multiBandInfoList, include the multiBandInfoList;
        5> if the cell broadcasts the freqBandIndicatorPriority, include the
          freqBandIndicatorPriority;
1> if the corresponding measObject concerns NR:
  2> if the reportSFTD-Meas is set to true within the corresponding reportConfigNR for this
    measId:
    3> set the measResultSFTD-NR in accordance with the following:
      4> set sfn-OffsetResult and frameBoundaryOffsetResult to the measurement results
        provided by lower layers;
      4> if the reportRSRP is set to true;
        5> set rsrp-Result to the RSRP of the NR PSCell derived based on SSB;
  2> else if the reportSFTD-NeighMeas is included within the corresponding reportConfigNR for
    this measId:
    3> for each applicable cell which measurement results are available, include an entry in the
      measResultCellListSFTD-NR and set the contents as follows:
      4> set physCellId to the physical cell identity of the concerned NR neighbour cell.
      4> set sfn-OffsetResult and frameBoundaryOffsetResult to the measurement results
        provided by lower layers;
      4> if the reportRSRP is set to true:
        5> set rsrp-Result to the RSRP of the concerned cell derived based on SSB;
1> else if the corresponding measObject concerns E-UTRA:
  2> if the reportSFTD-Meas is set to true within the corresponding reportConfigInterRAT for this
    measId:
    3> set the measResultSFTD-EUTRA in accordance with the following:
      4> set sfn-OffsetResult and frameBoundaryOffsetResult to the measurement results
        provided by lower layers;
      4> if the reportRSRP is set to true;
        5> set rsrpResult-EUTRA to the RSRP of the EUTRA PSCell;
1> if average uplink PDCP delay values are available:
  2> set the ul-PDCP-DelayValueResultList to include the corresponding average uplink PDCP
    delay values;
1> if PDCP excess delay measurements are available:
  2> set the ul-PDCP-ExcessDelayResultList to include the corresponding PDCP excess delay
    measurements;
1> if the includeCommonLocationInfo is configured in the corresponding reportConfig for this
  measId and detailed location information that has not been reported is available, set the content
  of commonLocationInfo of the locationInfo as follows:
  2> include the locationTimestamp;
  2> include the locationCoordinate, if available;
  2> include the velocityEstimate, if available;
  2> include the locationError, if available;
  2> include the locationSource, if available;
  2> if available, include the gnss-TOD-msec,
1> if the coarseLocationRequest is set to true in the corresponding reportConfig for this measId:
  2> include coarseLocationInfo, if available;
1> if the includeWLAN-Meas is configured in the corresponding reportConfig for this measId, set
  the wlan-LocationInfo of the locationInfo in the measResults as follows:
  2> if available, include the LogMeasResultWLAN, in order of decreasing RSSI for WLAN APs;
1> if the includeBT-Meas is configured in the corresponding reportConfig for this measId, set the
  BT-LocationInfo of the locationInfo in the measResults as follows:
  2> if available, include the LogMeasResultBT, in order of decreasing RSSI for Bluetooth
    beacons;
1> if the includeSensor-Meas is configured in the corresponding reportConfig for this measId, set
  the sensor-LocationInfo of the locationInfo in the measResults as follows:
  2> if available, include the sensor-MeasurementInformation;
  2> if available, include the sensor-MotionInformation;
1> if there is at least one applicable transmission resource pool for NR sidelink
  communication/discovery (for measResultsSL):
  2> set the measResultsListSL to include the CBR measurement results in accordance with the
    following:
    3> if the reportType is set to eventTriggered:
      4> include the transmission resource pools included in the poolsTriggeredList as defined
        within the VarMeasReportList for this measId;
    3> else:
      4> include the applicable transmission resource pools for which the new measurement
        results became available since the last periodical reporting or since the measurement
        was initiated or reset;
    3> if the corresponding measObject concerns NR sidelink communication/discovery, then for
      each transmission resource pool to be reported:
      4> set the sl-poolReportIdentity to the identity of this transmission resource pool;
      4> set the sl-CBR-ResultsNR to the CBR measurement results on PSSCH and PSCCH of
        this transmission resource pool provided by lower layers, if available;
NOTE 1: Void.
1> if there is at least one applicable CLI measurement resource to report:
  2> if the reportType is set to cli-EventTriggered or cli-Periodical:
    3> set the measResultCLI to include the most interfering SRS resources or most interfering
      CLI-RSSI resources up to maxReportCLI in accordance with the following:
      4> if the reportType is set to cli-EventTriggered:
        5> if trigger quantity is set to srs-RSRP i.e. i1-Threshold is set to srs-RSRP:
          6> include the SRS resource included in the cli-TriggeredList as defined within the
            VarMeasReportList for this measId;
        5> if trigger quantity is set to cli-RSSI i.e. i1-Threshold is set to cli-RSSI:
          6> include the CLI-RSSI resource included in the cli-TriggeredList as defined
            within the VarMeasReportList for this measId;
      4> else:
        5> if reportQuantityCLI is set to srs-rsrp:
          6> include the applicable SRS resources for which the new measurement results
            became available since the last periodical reporting or since the measurement
            was initiated or reset;
        5> else:
          6> include the applicable CLI-RSSI resources for which the new measurement
            results became available since the last periodical reporting or since the
            measurement was initiated or reset;
      4> for each SRS resource that is included in the measResultCLI:
        5> include the srs-ResourceId;
        5> set srs-RSRP-Result to include the layer 3 filtered measured results in decreasing
          order, i.e. the most interfering SRS resource is included first;
      4> for each CLI-RSSI resource that is included in the measResultCLI:
        5> include the rssi-ResourceId;
        5> set cli-RSSI-Result to include the layer 3 filtered measured results in decreasing
          order, i.e. the most interfering CLI-RSSI resource is included first;
1> if there is at least one applicable UE Rx-Tx time difference measurement to report:
  2> set measResultRxTxTimeDiff to the latest measurement result;
1> increment the numberOfReportsSent as defined within the VarMeasReportList for this measId by
  1;
1> stop the periodical reporting timer, if running;
1> if the numberOfReportsSent as defined within the VarMeasReportList for this measId is less than
  the reportAmount as defined within the corresponding reportConfig for this measId:
  2> start the periodical reporting timer with the value of reportInterval as defined within the
    corresponding reportConfig for this measId;
1> else:
  2> if the reportType is set to periodical or cli-Periodical or rxTxPeriodical:
    3> remove the entry within the VarMeasReportList for this measId;
    3> remove this measId from the measIdList within VarMeasConfig;
1> if the measurement reporting was configured by a sl-ConfigDedicatedNR received within the
  RRCConnectionReconfiguration:
  2> submit the MeasurementReport message to lower layers for transmission via SRB1,
    embedded in E-UTRA RRC message ULInformationTransferIRAT as specified TS 36.331
    [10], clause 5.6.28;
1> else if the UE is in (NG)EN-DC:
  2> if SRB3 is configured and the SCG is not deactivated:
    3> submit the MeasurementReport message via SRB3 to lower layers for transmission, upon
      which the procedure ends;
  2> else:
    3> submit the MeasurementReport message via E-UTRA embedded in E-UTRA RRC
      message ULInformationTransferMRDC as specified in TS 36.331 [10].
1> else if the UE is in NR-DC:
  2> if the measurement configuration that triggered this measurement report is associated with the
    SCG:
    3> if SRB3 is configured and the SCG is not deactivated:
      4> submit the MeasurementReport message via SRB3 to lower layers for transmission,
        upon which the procedure ends;
    3> else:
      4> submit the MeasurementReport message via SRB1 embedded in NR RRC message
        ULInformationTransferMRDC as specified in 5.7.2a.3;
  2> else:
    3> submit the MeasurementReport message via SRB1 to lower layers for transmission, upon
      which the procedure ends;
1> else:
  2> submit the MeasurementReport message to lower layers for transmission, upon which the
    procedure ends.
```

In FIG. 5, the base station 502 may transmit a predetermined RRC message (e.g., MobilityFromNRCommand or an RRC connection release message containing RedirectedCarrierInfo indicating movement to a particular frequency) to each terminal 501 or 503 so as to move each terminal 501 or 503 to a particular inter-RAT target cell, based on the measurement result message received from each terminal 501 or 503 in steps 530 and 531. For example, the base station 502 may instruct the first terminal 501 to move to a target cell belonging to E-UTRA carrier frequency x in step 530 and instruct the second terminal 503 to move to a target cell belonging to E-UTRA carrier frequency z in step 531.

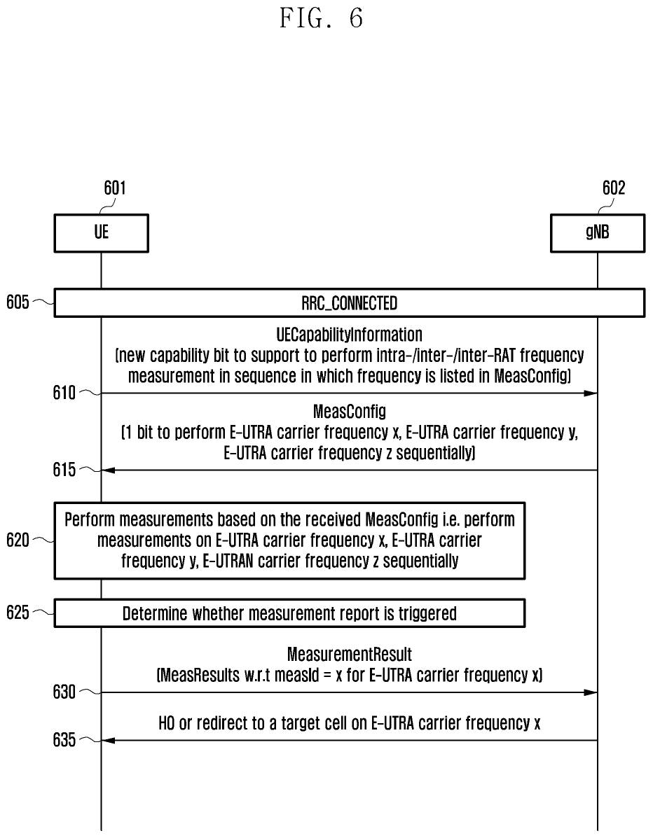

FIG. 6 illustrates a process in which a terminal transmits a measurement result message to a base station in a next generation mobile communication system according to an embodiment.

As described above, the terminal may first measure a particular frequency, based on a configuration of the base station when measuring frequencies configured by the base station. If VOLTE is optimally provided at a particular frequency, the base station may configure the terminal to first measure the optimal frequency so as to provide the service to the terminal at the optimal frequency. This is performed sin providing, by the base station, a predetermined handover message or an RRC connection release message including RedirectedCarrierInfo indicating movement to a particular frequency, to the terminal to redirect the terminal to a particular target cell as described above is performed based on a measurement result message transmitted by the terminal. For example, when E-UTRA frequency x is a frequency optimized for the VOLTE service, when providing measurement configuration information (E-UTRA frequency x, E-UTRA frequency y, and E-UTRA frequency z) to the terminal to which the base station is to provide the VOLTE service, the base station may configure the terminal to first measure E-UTRA frequency x and transmit a measurement result message based thereon to the base station, thereby moving the terminal to a cell belonging to E-UTRA frequency x.

Referring to FIG. 6, a terminal 601 may establish an RRC connection with an NR base station 602 to be in an RRC connected mode (RRC_CONNECTED) in step 605.

In step 610, the terminal 601 may transmit a terminal capability information message (UECapabilityInformation) to the base station 602. For example, such the terminal capability information message (UECapabilityInformation) may be transmitted based on a request (UECapabilityEnquiry) of the base station 602. The terminal capability information message may include capability information (new capability bit to support to perform intra-/inter-/inter-RAT frequency measurement in sequence in which frequency is listed in MeasConfig) indicating that the terminal 601 is able to perform measurement corresponding to a sequence of a frequency list included in measurement configuration information configured by the base station 602. For example, the capability information may indicate a measurement capability of the terminal corresponding to a sequence of measObjects included in MeasObjectToAddModList. Alternatively, the capability information may indicate a measurement capability of the terminal corresponding to a sequence of measIds included in MeasIdToAddModList.

The base station 602 may transmit a predetermined RRC message (e.g., RRCReconfiguration) including measurement configuration information (MeasConfig) to the terminal 601 in step 615. Herein, the drawings illustrate a procedure of providing, by a base station, measurement configuration information for a terminal after receiving a capability information message of the terminal, but a procedure of receiving a capability information message from a terminal may be omitted.

When the capability information message is received from the terminal 601, the base station 602 may provide measurement configuration information to the terminal 601, based on the capability information message of the terminal 601. In addition, pieces of information included in the measurement configuration information (MeasConfig) may proceed the information described above in the FIG. 5.

For conciseness, a case where the base station 602 configures three frequencies, that is, E-UTRA carrier frequency x, E-UTRA carrier frequency y, and E-UTRA carrier frequency z for the terminal 601 through the measurement configuration information, and sequentially includes the three frequencies in MeasObjectToAddModList or MeasIdToAddModList is described, but the disclosure is not limited thereto. Each MeasObjectToAddMod included in MeasObjectToAddModList is configured by measObjectId and MeasObject, MeasObjectEUTRA (i.e., one of E-UTRA carrier frequency x, E-UTRA carrier frequency y, and E-UTRA carrier frequency z) may be configured as MeasObject, and MeasObjectToAddModList may sequentially include (measObjectId x, E-UTRA carrier frequency x), (measObjectId y, E-UTRA carrier frequency y), and (measObjectId z, E-UTRA carrier frequency z). For example, each MeasIdToAddMod included in MeasIdToAddModList is configured by measId, measObjectId, and reportConfigId, and MeasIdToAddModList may sequentially include (measId x, measObjectId x, reportConfigId x), (measId y, measObjectId y, reportConfigId y), and (measId z, measObjectId z, reportConfigId z). When configuring measurement configuration information for the terminal, the base station may include, in the measurement configuration information, an indicator indicating sequential frequency measurement corresponding to information present in MeasObjectToAddModList or MeasIdToAddModList and provide same. The terminal may sequentially measure E-UTRA carrier frequency x, E-UTRA carrier frequency y, and E-UTRA carrier frequency z according to the indicator.

In step 620, the terminal 601 may perform measurement, based on the measurement configuration information received from the base station 602. The terminal 601 may measure the configured frequencies according to a sequence of measObjects included in MeasObjectToAddModList configured in MeasConfig (i.e., a sequence of E-UTRA frequency x, E-UTRA frequency y, and E-UTRA frequency z). The terminal 601 may perform measurement according to a sequence of measIds included in measIdToAddModList (measId x, measObjectId x (i.e., E-UTRA frequency x), reportConfigId 1), (measId y, measObjectId y (i.e., E-UTRA frequency y), reportConfigId2), and (measId z, measObjectId z (i.e., E-UTRA frequency z), reportConfigId z)). A specific measurement method may proceed the above-described information.

In step 625, the terminal 601 may determine, based on a result of the measurement in step 620, whether a condition for reporting a measurement result message (MeasurementReport) to the base station 602 is triggered. Similarly, the determination may proceed the above-described information.

In step 625, when the terminal 601 determines that the condition for reporting the measurement result message has been triggered, in step 630, the terminal 601 may include a measurement result (measResults) for measId, a measurement reporting procedure of which has been triggered, in the measurement result message (MeasurementReport) and transmit same to the base station 602. Accordingly, the terminal 601 may first measure E-UTRA carrier frequency x and trigger a measurement reporting procedure, based on measId (i.e., measId=x, measObjectId=x, reportConfigId=x) associated therewith. A detailed procedure of including a measurement result (MeasResults) in a measurement reporting message by the terminal 601 may proceed the above-described information.

In step 635, the base station 602 may transmit a predetermined RRC message (e.g., MobilityFromNRCommand or an RRC connection release message including RedirectedCarrierInfo indicating movement to a particular frequency) to the terminal 601 to redirect the terminal 601 to a particular inter-RAT target cell, based on the measurement result message received from the terminal 601. For example, the base station 602 may configure the terminal 601 to move to a target cell belonging to E-UTRA carrier frequency x and accordingly, the VOLTE service may be optimally provided to the terminal.

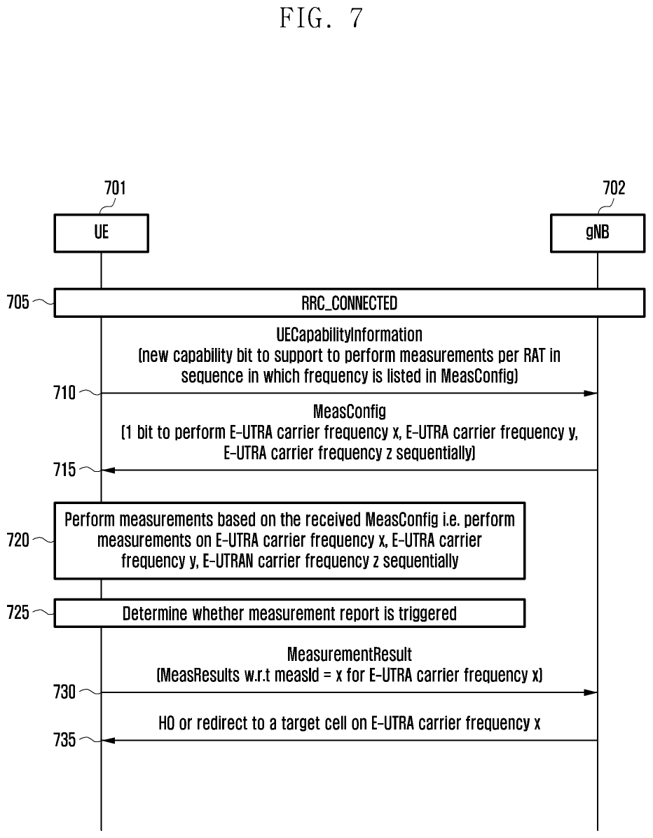

FIG. 7 illustrates a process in which a terminal transmits a measurement result message to a base station in a next generation mobile communication system according to an embodiment.

As described above, the terminal may first measure a particular frequency for each RAT, based on a configuration of the base station when measuring frequencies configured by the base station. If a predetermined service (e.g., VOLTE) is optimally provided at a particular frequency, the base station may configure the terminal to first measure the optimal frequency so as to provide the service to the terminal at the optimal frequency. This is performed since providing, by the base station, a predetermined handover (HO) message or an RRC connection release message including RedirectedCarrierInfo indicating movement to a particular frequency, to the terminal to redirect the terminal to a particular target cell as described above is performed based on a measurement result message transmitted by the terminal. For example, when E-UTRA frequency x is a frequency optimized for the VOLTE service, when configuring measurement configuration information (E-UTRA frequency x, E-UTRA frequency y, and E-UTRA frequency z) to the terminal to which the base station is to provide the VOLTE service, the base station may allow the terminal to first measure E-UTRA frequency x and transmit a measurement result message based thereon to the base station, thereby moving the terminal to a cell belonging to E-UTRA frequency x.

Referring to FIG. 7, a terminal 701 may establish an RRC connection with an NR base station 702 to be in an RRC connected mode (RRC_CONNECTED) in step 705.

In step 710, the terminal 701 may transmit a terminal capability information message (UECapabilityInformation) to the base station 702. For example, such the terminal capability information message (UECapabilityInformation) may be transmitted based on a request (UECapabilityEnquiry) of the base station 702. The terminal capability information message may include capability information (new capability bit to support to perform measurements per RAT in sequence in which frequency is listed in MeasConfig) indicating that the terminal 701 is able to perform measurement corresponding to a sequence of a frequency list for each RAT included in measurement configuration information configured by the base station 702. The capability information may indicate a measurement capability of the terminal corresponding to a sequence of measObjects for each RAT included in MeasObjectToAddModList. Alternatively, the capability information may indicate a measurement capability of the terminal corresponding to a sequence of measIds for each RAT included in MeasIdToAddModList. The capability information may be separately indicated for each RAT. The above contents may be separately indicated for each frequency range (FR) or each RAT in each FR, and may indicate a measurement capability of the terminal corresponding to a sequence of frequencies in MeasObjectToAddModList or MeasIdToAddModList for each FR or each RAT in each FR.

The base station 702 may transmit a predetermined RRC message (e.g., RRCReconfiguration) including measurement configuration information (MeasConfig) to the terminal 701 in step 715. Pieces of information included in the measurement configuration information (MeasConfig) may proceed the above-described information.

For conciseness, a case where the base station 702 configures three frequencies, that is, E-UTRA carrier frequency x, E-UTRA carrier frequency y, and E-UTRA carrier frequency z for the terminal 701 through the measurement configuration information, and sequentially includes the three frequencies in MeasObjectToAddModList or MeasIdToAddModList is described as an example, but frequencies configured by the base station 702 and the sequence are not limited thereto. Each MeasObjectToAddMod included in MeasObjectToAddModList is configured by measObjectId and MeasObject, MeasObjectEUTRA (i.e., one of E-UTRA carrier frequency x, E-UTRA carrier frequency y, and E-UTRA carrier frequency z) may be configured as MeasObject, and MeasObjectToAddModList may sequentially include (measObjectId x, E-UTRA carrier frequency x), (measObjectId y, E-UTRA carrier frequency y), and (measObjectId z, E-UTRA carrier frequency z). For example, each MeasIdToAddMod included in MeasIdToAddModList is configured by measId, measObjectId, and reportConfigId, and MeasIdToAddModList may sequentially include (measId x, measObjectId x, reportConfigId x), (measId y, measObjectId y, reportConfigId y), and (measId z, measObjectId z, reportConfigId z). When configuring measurement configuration information for the terminal 701, the base station 702 may include, in the measurement configuration information, an indicator indicating sequential frequency measurement corresponding to information present in MeasObjectToAddModList or MeasIdToAddModList and provide same. The terminal 701 may sequentially measure E-UTRA carrier frequency x, E-UTRA carrier frequency y, and E-UTRA carrier frequency z according to the indicator. For reference, if an indicator indicating sequential frequency measurement corresponding to information present in MeasObjectToAddModList or MeasIdToAddModList is configured with respect to both NR and E-UTRA, the measurement configuration information may additionally include an indicator indicating which RAT among NR and E-UTRA is prioritized to measure frequency. However, if there is no indicator described above, the terminal may prioritize one RAT among the two RATs to measure frequency.

In step 720, the terminal 701 may perform measurements, based on the measurement configuration information received from the base station 702. The terminal 701 may measure the configured frequencies according to a sequence of measObjects included in MeasObjectToAddModList configured in MeasConfig (i.e., a sequence of E-UTRA frequency x, E-UTRA frequency y, and E-UTRA frequency z). As another example, the terminal 701 may perform measurement according to a sequence of measIds included in measIdToAddModList (measId x, measObjectId x (i.e., E-UTRA frequency x), reportConfigId 1), (measId y, measObjectId y (i.e., E-UTRA frequency y), reportConfigId2), and (measId z, measObjectId z (i.e., E-UTRA frequency z), reportConfigId z)). A specific measurement method may proceed the above-described information.

In step 725, the terminal 701 may determine, based on a result of the measurement in step 720, whether a condition for reporting a measurement result message (MeasurementReport) to the base station 702 is triggered. Similarly, the determination may proceed the above-described information.

In step 725, when the terminal 701 determines that the condition for reporting the measurement result message has been triggered, the terminal 701 may include a measurement result (measResults) for measId, a measurement reporting procedure of which has been triggered, in the measurement result message (MeasurementReport) and transmit same to the base station 702. Accordingly, the terminal 701 may first measure E-UTRA carrier frequency x and trigger a measurement reporting procedure, based on measId (i.e., measId=x, measObjectId=x, reportConfigId=x) associated therewith. A detailed procedure of including a measurement result (MeasResults) in a measurement reporting message by the terminal 701 may proceed the above-described information.

In step 735, the base station 702 may transmit a predetermined RRC message (e.g., MobilityFromNRCommand or an RRC connection release message including RedirectedCarrierInfo indicating movement to a particular frequency) to the terminal 701 so as to redirect the terminal to a particular inter-RAT target cell, based on the measurement result message received from the terminal 701. For example, the base station 702 may configure the terminal 701 to move to a target cell belonging to E-UTRA carrier frequency x and accordingly, provide the VOLTE service to the terminal 701.

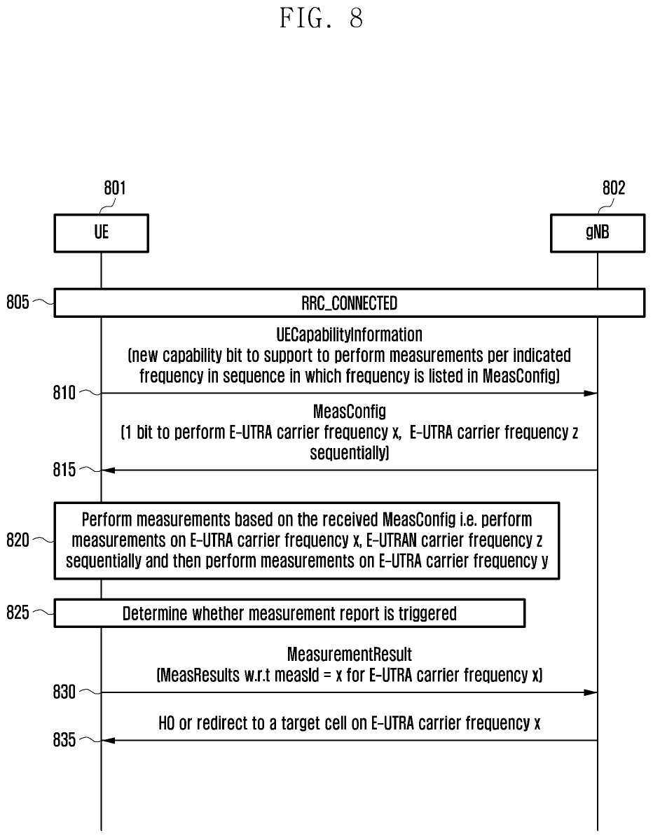

FIG. 8 illustrates a process in which a terminal transmits a measurement result message to a base station in a next generation mobile communication system according to an embodiment.

As described above, the terminal may first measure a particular frequency, based on a configuration of the base station when measuring frequencies configured by the base station. If a predetermined service (e.g., VOLTE) is optimally provided at a particular frequency, the base station may configure the terminal to first measure the optimal frequency so as to provide the service to the terminal at the optimal frequency. This is performed since providing, by the base station, a predetermined RRC message (e.g., a handover message or an RRC connection release message including RedirectedCarrierInfo indicating movement to a particular frequency) to the terminal to redirect the terminal to a particular target cell is performed based on a measurement result message transmitted by the terminal. For example, when E-UTRA frequency x is a frequency optimized for the VOLTE service, when configuring measurement configuration information (E-UTRA frequency x, E-UTRA frequency y, and E-UTRA frequency z) to the terminal to which the base station is to provide the VOLTE service, the base station may allow the terminal to first measure E-UTRA frequency x and transmit a measurement result message based thereon to the base station, thereby moving the terminal to a cell belonging to E-UTRA frequency X.

Referring to FIG. 8, a terminal 801 may establish an RRC connection with an NR base station 802 to be in an RRC connected mode (RRC_CONNECTED) in step 805.

In step 810, the terminal 801 may transmit a terminal capability information message (UECapabilityInformation) to the base station 802. For example, such the terminal capability information message (UECapabilityInformation) may be transmitted based on a request (UECapabilityEnquiry) of the base station 802. The terminal capability information message may include capability information (new capability bit to support to perform measurement per frequency in sequence in which frequency is listed in MeasConfig) indicating that the terminal 801 is able to first measure a particular frequency in a frequency list included in measurement configuration information configured by the base station 802, according to a configuration of the base station 802. For example, the capability information may indicate that preferential measurement of at least one measObject, for which a predetermined indicator is included among measObjects included in MeasObjectToAddModList, is possible based on a sequence in which the at least one measObject is included in the MeasObjectToAddModList. As another example, the capability information may indicate that preferential measurement of at least one measId, which includes a predetermined indicator among measIds for each RAT included in MeasIdToAddModList, is possible based on a sequence in which the at least one measId is included in the MeasIdToAddModList.

The base station 802 may transmit a predetermined RRC message (e.g., RRCReconfiguration) including measurement configuration information (MeasConfig) to the terminal 801 in step 815. Pieces of information included in the measurement configuration information (MeasConfig) may proceed the above-described information.

For conciseness, a case where the base station 802 configures three frequencies, that is, E-UTRA carrier frequency x, E-UTRA carrier frequency y, and E-UTRA carrier frequency z for the terminal 801 through the measurement configuration information, and sequentially includes the three frequencies in MeasObjectToAddModList or MeasIdToAddModList is described as an example, but frequencies configured by the base station 802 and the sequence are not limited thereto. Each MeasObjectToAddMod included in MeasObjectToAddModList is configured by measObjectId and MeasObject, MeasObjectEUTRA (i.e., one of E-UTRA carrier frequency x, E-UTRA carrier frequency y, and E-UTRA carrier frequency z) may be configured as MeasObject, and MeasObjectToAddModList may sequentially include (measObjectId x, E-UTRA carrier frequency x), (measObjectId y, E-UTRA carrier frequency y), and (measObjectId z, E-UTRA carrier frequency z). For example, each MeasIdToAddMod included in MeasIdToAddModList is configured by measId, measObjectId, and reportConfigId, and MeasIdToAddModList may sequentially include (measId x, measObjectId x, reportConfigId x), (measId y, measObjectId y, reportConfigId y), and (measId z, measObjectId z, reportConfigId z).

The base station 802 may configure a predetermined indicator for each MeasObject or each MeasId when configuring the measurement configuration information for the terminal 801. For example, the predetermined indicator may be an indicator of 1 bit. Therefore, the terminal 801 may preferentially perform a frequency measurement operation for MeasObject or MeasId including a predetermined indicator to correspond to a sequence in which the MeasObject or MeasId is included in MeasObjectToAddModList or MeasIdToAddModList. The base station may additionally configure the predetermined indicator for MeasObject or MeasId corresponding to each of E-UTRA carrier frequency x and E-UTRA carrier frequency z so that the terminal first sequentially measures E-UTRA carrier frequency x and E-UTRA carrier frequency z and then measures E-UTRA carrier frequency y. For reference, a frequency (e.g., E-UTRA carrier frequency y) not having the indicator is not required to be measured according to a sequence in which the frequency is included in MeasObjectToAddModList or MeasIdToAddModList. As another example, the base station 802 may also configure which frequency among the configured frequencies is to be first measured, in a form of a bitmap. The form of the bitmap, that is, the size or configuration value of the bitmap may be determined according to the number of MeasurementObjects configurable by the base station 802. The base station 802 may additionally configure information indicating which frequency among the configured frequencies is to be first measured by the terminal 801, in a form of a bitmap or a form of a list.

In step 820, the terminal 801 may perform measurements, based on the measurement configuration information received from the base station 802. The terminal 801 according to the disclosure may measure the configured frequencies according to a sequence of measObjects included in MeasObjectToAddModList configured in MeasConfig (i.e., a sequence of E-UTRA frequency x and E-UTRA frequency z). As another example, the terminal 801 may perform measurements according to a sequence of measIds included in measIdToAddModList (measId x, measObjectId x (i.e., E-UTRA frequency x), reportConfigId 1) and (measId z, measObjectId z (i.e., E-UTRA frequency z), reportConfigId z)). When sequential measurement of the frequencies configured together with a predetermined indicator is completed, the terminal 801 may measure the remaining frequency, that is, E-UTRA frequency y. A specific measurement method may proceed the above-described information.

In step 825, the terminal 801 may determine, based on a result of the measurement in step 820, whether a condition for reporting a measurement result message (MeasurementReport) to the base station 802 is triggered. Similarly, the determination may proceed the above-described information.

In step 825, when the terminal 801 determines that the condition for reporting the measurement result message has been triggered, the terminal 801 may include a measurement result (measResults) for measId, a measurement reporting procedure of which has been triggered, in the measurement result message (MeasurementReport) and transmit same to the base station 802. Accordingly, the terminal 801 may first measure E-UTRA carrier frequency x and trigger a measurement reporting procedure, based on measId (i.e., measId=x, measObjectId=x, reportConfigId=x) associated therewith. A detailed procedure of including a measurement result (MeasResults) in a measurement reporting message by the terminal 801 may proceed the above-described information.

In step 835, the base station 802 may transmit a predetermined RRC message (e.g., MobilityFromNRCommand or an RRC connection release message including RedirectedCarrierInfo indicating movement to a particular frequency) so as to redirect the terminal 801 to a particular inter-RAT target cell, based on the measurement result message received from the terminal 801. For example, the base station 802 may configure the terminal 801 to move to a target cell belonging to E-UTRA carrier frequency x and accordingly, optimally provide the VOLTE service to the terminal 801.

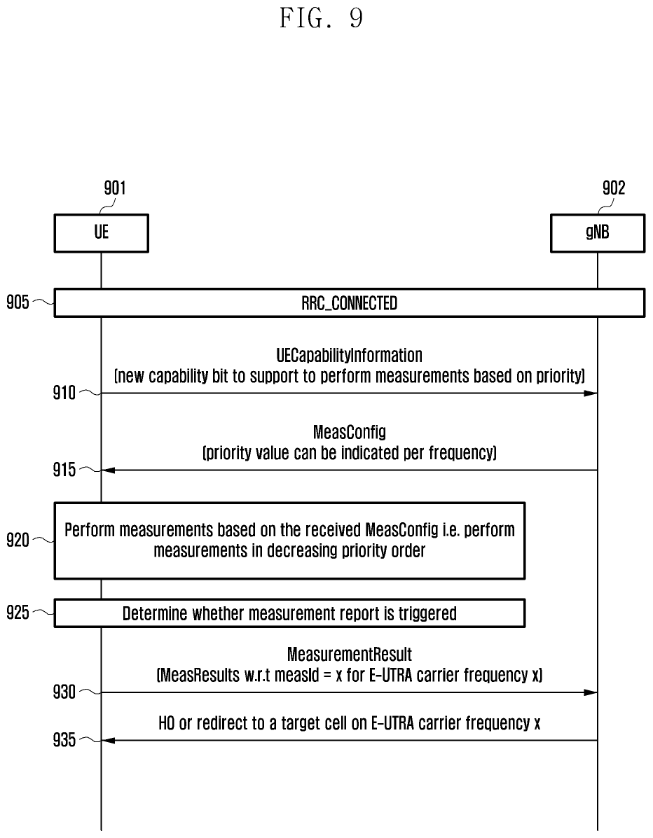

FIG. 9 illustrates a process in which a terminal transmits a measurement result message to a base station in a next generation mobile communication system according to an embodiment.

When measuring frequencies configured by the base station, the terminal may measure the frequencies in a sequence from the highest priority to the lowest according to a configuration of the base station. If VOLTE is optimally provided at a particular frequency, the base station may configure the optimal frequency to have the highest priority so as to provide the service to the terminal at the optimal frequency, thereby configuring the terminal to first measure the optimal frequency. This is performed since providing, by the base station, a predetermined RRC message (e.g., a handover message or an RRC connection release message including RedirectedCarrierInfo indicating movement to a particular frequency) to the terminal so as to redirect the terminal to a particular target cell as described above is performed based on a measurement result message transmitted by the terminal. For example, when E-UTRA frequency x is a frequency optimized for the VOLTE service, when configuring measurement configuration information (E-UTRA frequency x, E-UTRA frequency y, and E-UTRA frequency z) to the terminal to which the base station is to provide the VOLTE service, the base station may configure the priority of E-UTRA frequency x to be highest so as to allow the terminal to first measure E-UTRA frequency x and transmit a measurement result message based on frequency x to the base station, thereby re-locating the terminal to a cell belonging to E-UTRA frequency x.

Referring to FIG. 9, a terminal 901 may establish an RRC connection with an NR base station 902 to be in an RRC connected mode (RRC_CONNECTED) in step 905.

In step 910, the terminal 901 may transmit a terminal capability information message (UECapabilityInformation) to the base station 902. For example, such the terminal capability information message (UECapabilityInformation) may be transmitted based on a request (UECapabilityEnquiry) of the base station 902. The terminal capability information message may include a new capability bit to support to perform measurement based on priority indicating that, when the base station configures a measurement priority for each frequency, the terminal 901 is able to perform measurement based thereon.

The base station 902 may transmit an RRC message (e.g., RRCReconfiguration) including measurement configuration information (MeasConfig) to the terminal 901 in step 915. Pieces of information included in the measurement configuration information (MeasConfig) may proceed the above-described information.

For conciseness, when configuring, for the terminal 901 and through the measurement configuration information, three frequencies, that is, E-UTRA carrier frequency x, E-UTRA carrier frequency y, and E-UTRA carrier frequency z, the base station 902 may configure E-UTRA frequency x to have the highest priority value, configure E-UTRA frequency y to have the second highest priority value, and configure E-UTRA frequency z to have the lowest priority value. The terminal 901 may apply priorities lower than the priority values configured by the base station 902, to frequencies for which priority values are not configured, to determine a measurement sequence for frequencies. As another example, the base station 902 may configure the terminal 901 to first measure a particular E-UTRA frequency or the maximum number of E-UTRA frequencies may be determined according to a configuration of the base station.

In step 920, the terminal 901 may perform measurement, based on the measurement configuration information received from the base station 902. The terminal 901 may first measure frequencies having high priority values among the configured frequencies (UE measures frequencies in decreasing priority order). A specific measurement method may proceed the above-described information.

In step 925, the terminal 901 may determine, based on a result of the measurement in step 920, whether a condition for reporting a measurement result message (MeasurementReport) to the base station 902 is triggered. Similarly, the determination may proceed the above-described information.

In step 925, when the terminal 901 determines that the condition for reporting the measurement result message has been triggered, the terminal 901 may include a measurement result (measResults) for measId, a measurement reporting procedure of which has been triggered, in the measurement result message (MeasurementReport) and transmit same to the base station 902. Accordingly, the terminal 901 may first measure E-UTRA carrier frequency x, based on the highest priority value being configured for E-UTRA carrier frequency x, and trigger a measurement reporting procedure for measId (i.e., measId=x, measObjectId=x, reportConfigId=x) associated therewith. A detailed procedure of including a measurement result (MeasResults) in a measurement reporting message by the terminal 901 may proceed the above-described information.

In step 935, the base station 902 may transmit a predetermined RRC message (e.g., MobilityFromNRCommand or an RRC connection release message including RedirectedCarrierInfo indicating movement to a particular frequency) so as to redirect the terminal 901 to a particular inter-RAT target cell, based on the measurement result message received from the terminal 901. For example, the base station 902 may configure the terminal 901 to relocate to a target cell belonging to E-UTRA carrier frequency x and accordingly, optimally provide the VOLTE service to the terminal 901.

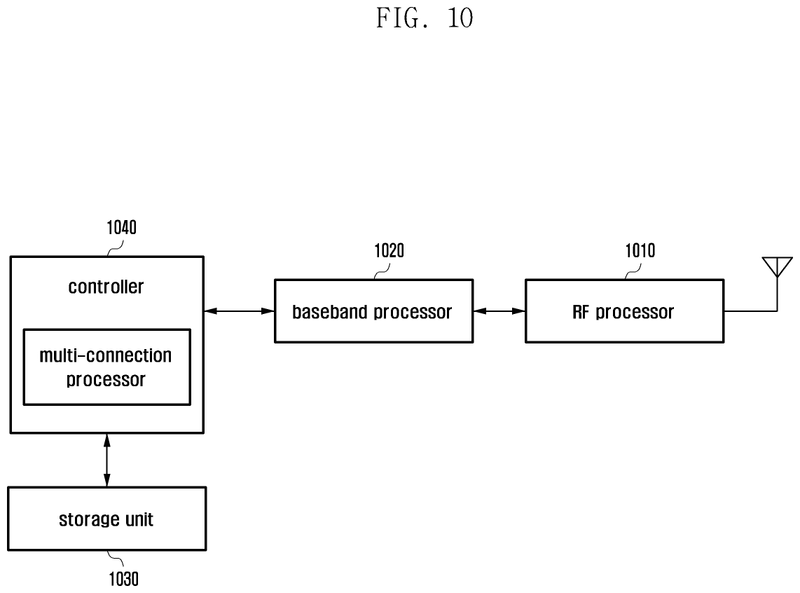

FIG. 10 illustrates an internal structure of a terminal according to an embodiment.

Referring to FIG. 10, the terminal includes a radio frequency (RF) processor 1010, a baseband processor 1020, a storage unit 1030, and a controller 1040.

The RF processor 1010 performs a function, such as signal band change, amplification, etc., for transmitting or receiving a signal through a wireless channel. That is, the RF processor 1010 upconverts a baseband signal provided from the baseband processor 1020, into an RF band signal, and then transmits the RF band signal through an antenna, and downconverts an RF band signal received through the antenna, into a baseband signal. The RF processor 1010 may include a transmission filter, a reception filter, an amplifier, a mixer, an oscillator, a digital-to-analog converter (DAC), an analog-to-digital converter (ADC), and the like. In the above diagram, only one antenna is illustrated, but the terminal may include a plurality of antennas. The RF processor 1010 may include a plurality of RF chains. Furthermore, the RF processor 1010 may perform beamforming. To perform the beamforming, the RF processor 1010 may adjust the phase and size of each of signals transmitted or received through a plurality of antennas or antenna elements. The RF processor may perform MIMO, and may receive several layers when a MIMO operation is performed.

The baseband processor 1020 performs a function of conversion between a baseband signal and a bitstream according to a physical layer specification of a system. For example, at the time of data transmission, the baseband processor 1020 generates complex symbols by encoding and modulating a transmission bit stream. In addition, at the time of data reception, the baseband processor 1020 reconstructs a reception bit stream by demodulating and decoding a baseband signal provided from the RF processor 1010. For example, when an OFDM scheme is applied, at the time of data transmission, the baseband processor 1020 generates complex symbols by encoding and modulating a transmission bit stream, maps the complex symbols to subcarriers, and then configures OFDM symbols through inverse fast Fourier transform (IFFT) calculation and cyclic prefix (CP) insertion. In addition, at the time of data reception, the baseband processor 1020 divides a baseband signal provided from the RF processor 1010, by the units of OFDM symbols, reconstructs signals mapped to subcarriers, through fast Fourier transform (FFT), and then reconstructs a reception bitstream through demodulation and decoding.

The baseband processor 1020 and the RF processor 1010 transmit and receive a signal as described above. Accordingly, the baseband processor 1020 and the RF processor 1010 may be called a transmitter, a receiver, a transceiver, or a communication unit. At least one of the baseband processor 1020 and the RF processor 1010 may include a plurality of communication modules to support a plurality of different wireless access technologies. In addition, at least one of the baseband processor 1020 and the RF processor 1010 may include different communication modules to process signals in different frequency bands. For example, the different wireless access technologies may include wireless LAN, a cellular network (e.g., LTE), etc. The different frequency bands may include a super high frequency (SHF) (e.g., 2.NR hertz (Hz), NRhz) band, a millimeter (mm) wave (e.g., 60 GHz) band, etc.

The storage unit 1030 stores data such as a basic program, an application program, and configuration information for an operation of the terminal. Particularly, the storage unit 1030 may store information related to a second access node that performs wireless communication by using a second wireless access technology. The storage unit 1030 provides stored data in response to a request of the controller 1040.

The controller 1040 controls overall operations of the terminal. For example, the controller 1040 transmits or receives a signal via the baseband processor 1020 and the RF processor 1010. The controller 1040 records and reads data in and from the storage unit 1030. To this end, the controller 1040 may include at least one processor. For example, the controller 1040 may include a communication processor (CP) performing control for communication, and an application processor (AP) controlling a higher layer, such as an application program.

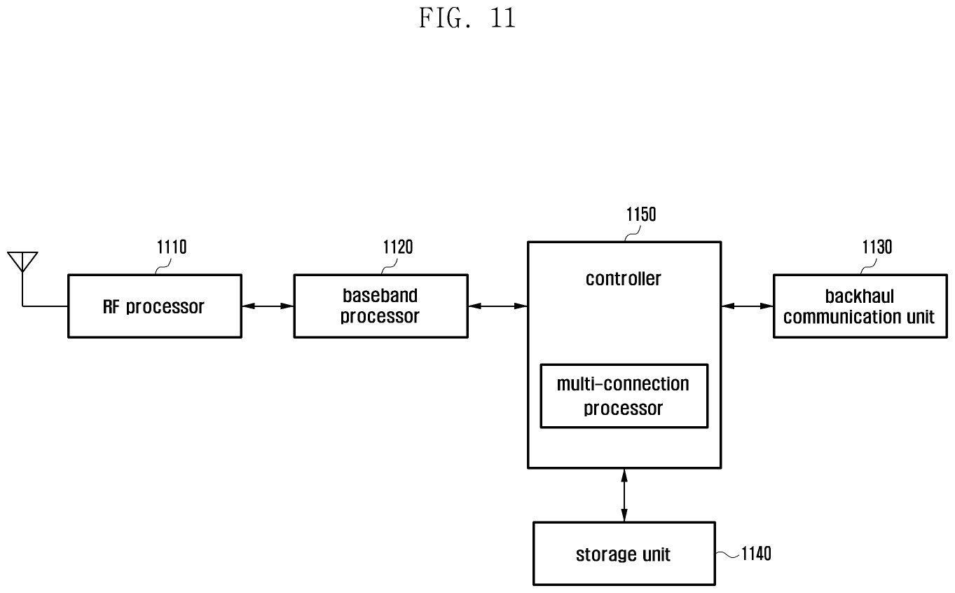

FIG. 11 illustrates a configuration of an NR base station according to an embodiment.

Referring to FIG. 11, the base station includes an RF processor 1110, a baseband processor 1120, a backhaul communication unit 1130, a storage unit 1140, and a controller 1150.

The RF processor 1110 performs a function, such as signal band change, amplification, etc., for transmitting or receiving a signal through a wireless channel. That is, the RF processor 1110 upconverts a baseband signal provided from the baseband processor 1120, into an RF band signal, and then transmits the RF band signal through an antenna, and downconverts an RF band signal received through the antenna, into a baseband signal. For example, the RF processor 1110 may include a transmission filter, a reception filter, an amplifier, a mixer, an oscillator, a DAC, an ADC, and the like. In the diagram, only one antenna is illustrated, but the first access node may include a plurality of antennas. The RF processor 1110 may include a plurality of RF chains and may perform beamforming. To perform the beamforming, the RF processor 1110 may adjust the phase and size of each of signals transmitted or received through a plurality of antennas or antenna elements. The RF processor may perform a downlink MIMO operation by transmitting one or more layers.

The baseband processor 1120 performs a function of conversion between a baseband signal and a bitstream according to a physical layer specification of a first wireless access technology. For example, at the time of data transmission, the baseband processor 1120 generates complex symbols by encoding and modulating a transmission bit stream. In addition, at the time of data reception, the baseband processor 1120 reconstructs a reception bit stream by demodulating and decoding a baseband signal provided from the RF processor 1110. For example, when an OFDM scheme is applied, at the time of data transmission, the baseband processor 1120 generates complex symbols by encoding and modulating a transmission bit stream, maps the complex symbols to subcarriers, and then configures OFDM symbols through IFFT calculation and CP insertion. In addition, at the time of data reception, the baseband processor 1120 divides a baseband signal provided from the RF processor 1110, by the units of OFDM symbols, reconstructs signals mapped to subcarriers, through FFT calculation, and then reconstructs a reception bitstream through demodulation and decoding. The baseband processor 1120 and the RF processor 1110 transmit and receive a signal as described above. Accordingly, the baseband processor 1120 and the RF processor 1110 may be called a transmitter, a receiver, a transceiver, a communication unit, or a wireless communication unit.

The backhaul communication unit 1130 provides an interface for performing communication with other nodes within a network. That is, the backhaul communication unit 1130 converts, into a physical signal, a bitstream transmitted from the main base station to another node, for example, an auxiliary base station, a core network, etc., and converts a physical signal received from the other node, into a bitstream.

The storage unit 1140 stores data such as a basic program, an application program, and configuration information for an operation of the main base station. Particularly, the storage unit 1140 may store information relating to a bearer assigned to a connected terminal, a measurement result reported from a connected terminal, etc. The storage unit 1140 may store information serving as a determination criterion of whether to provide or stop providing multi-connection to a terminal. Then, the storage unit 1140 provides stored data in response to a request of the controller 1150.

The controller 1150 controls overall operations of the main base station. For example, the controller 1150 transmits or receives a signal via the baseband processor 1120 and the RF processor 1110, or via the backhaul communication unit 1130. The controller 1150 records and reads data in and from the storage unit 1140. To this end, the controller 1150 may include at least one processor.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a base station in a wireless communication system, the method comprising:
transmitting, to a terminal, a radio resource control message including configuration information on at least one measurement to be performed by the terminal, the configuration information including first information on measurement objects and second information on a report configuration; and
receiving, from the terminal, a measurement report including at least one measurement result based on the configuration information,
wherein the first information includes information indicating a measurement sequence of a corresponding measurement object among the measurement objects.

2. The method of claim 1, further comprising:
receiving, from the terminal, capability information including information indicating whether the terminal supports a measurement based on a configured measurement sequence, the measurement including at least one of an intra measurement or an inter-radio access technology measurement.

3. The method of claim 1,
wherein the measurement objects include a first measurement object and a second measurement object, and
wherein the first information includes information on a first value indicating that the first measurement object is measured firstly and information on a second value indicating that the second measurement object is measured secondly.

4. The method of claim 1,
wherein the measurement sequence for at least one measurement object among the measurement objects is not provided in the first information, and
wherein the measurement objects include a measurement object for new radio or a measurement object for evolved universal mobile telecommunication systems terrestrial radio access.

5. A method performed by a terminal in a wireless communication system, the method comprising:
receiving, from a base station, a radio resource control message including configuration information on at least one measurement to be performed by the terminal, the configuration information including first information on measurement objects and second information on a report configuration; and
transmitting, to the base station, a measurement report including at least one measurement result based on the configuration information,
wherein the first information includes information indicating a measurement sequence of a corresponding measurement object among the measurement objects.

6. The method of claim 5, further comprising:
transmitting, to the base station, capability information including information indicating whether the terminal supports a measurement based on a configured measurement sequence, the measurement including at least one of an intra measurement or an inter-radio access technology measurement.

7. The method of claim 5,
wherein the measurement objects include a first measurement object and a second measurement object, and
wherein the first information includes information on a first value indicating that the first measurement object is measured firstly and information on a second value indicating that the second measurement object is measured secondly.

8. The method of claim 5,
wherein the measurement sequence for at least one measurement object among the measurement objects is not provided in the first information, and
wherein the measurement objects include a measurement object for new radio or a measurement object for evolved universal mobile telecommunication systems terrestrial radio access.

9. A base station in a wireless communication system, the base station comprising:
a transceiver; and
a controller configured to:
control the transceiver to transmit, to a terminal, a radio resource control message including configuration information on at least one measurement to be performed by the terminal, the configuration information including first information on measurement objects and second information on a report configuration, and
control the transceiver to receive, from the terminal, a measurement report including at least one measurement result based on the configuration information,
wherein the first information includes information indicating a measurement sequence of a corresponding measurement object among the measurement objects.

10. The base station of claim 9,
wherein the controller is further configured to control the transceiver to receive, from the terminal, capability information including information indicating whether the terminal supports a measurement based on a configured measurement sequence, the measurement including at least one of an intra measurement or an inter-radio access technology measurement.

11. The base station of claim 9,
wherein the measurement objects include a first measurement object and a second measurement object, and
wherein the first information includes information on a first value indicating that the first measurement object is measured firstly and information on a second value indicating that the second measurement object is measured secondly.

12. The base station of claim 9,
wherein the measurement sequence for at least one measurement object among the measurement objects is not provided in the first information, and
wherein the measurement objects include a measurement object for new radio or a measurement object for evolved universal mobile telecommunication systems terrestrial radio access.

13. A terminal in a wireless communication system, the terminal comprising:
a transceiver; and
a controller configured to:
control the transceiver to receive, from a base station, a radio resource control message including configuration information on at least one measurement to be performed by the terminal, the configuration information including first information on measurement objects and second information on a report configuration, and
control the transceiver to transmit, to the base station, a measurement report including at least one measurement result based on the configuration information,
wherein the first information includes information indicating a measurement sequence of a corresponding measurement object among the measurement objects.

14. The terminal of claim 13,
wherein the controller is further configured to control the transceiver to transmit, to the base station, capability information including information indicating whether the terminal supports a measurement based on a configured measurement sequence, the measurement including at least one of intra measurement or inter-radio access technology measurement.

15. The terminal of claim 13,
wherein the measurement objects include a first measurement object and a second measurement object, and
wherein the first information includes information on a first value indicating that the first measurement object is measured firstly and information on a second value indicating that the second measurement object is measured secondly.

16. The terminal of claim 13,
wherein the measurement sequence for at least one measurement object among the measurement objects is not provided in the first information, and
wherein the measurement objects include a measurement object for new radio or a measurement object for evolved universal mobile telecommunication systems terrestrial radio access.
